(19) United States
(12) Patent Application Publication
(10) Pub. No.: US 2021/0074138 A1
(43) Pub. Date: Mar. 11, 2021

(54) AREA MONITORING AND COMMUNICATION

(71) Applicant: Greenwave Systems PTE. LTD., Singapore (SG)

(72) Inventors: Eric Scott Micko, Singapore Science Park II (SG); Sonny Windstrup, Singapore (SG)

(21) Appl. No.: 17/099,990

(22) Filed: Nov. 17, 2020

Related U.S. Application Data
(63) Continuation of application No. PCT/US19/34054, filed on May 24, 2019.
(60) Provisional application No. 62/677,153, filed on May 28, 2018.

(51) Int. Cl. G08B 21/04; G06K 9/00

(52) U.S. Cl. CPC G08B 21/043; G08B 21/0492; G08B 21/0476; G06K 2009/00738; G06K 9/00375; G06K 9/00711; G06K 9/00369

(57) ABSTRACT

A room monitoring apparatus includes an outer shell which includes a first area transparent to at least some wavelengths of infrared radiation, a second area transparent to visible light, and a third area adapted to be positioned on a surface. A static portion is fixed to a portion of the outer shell and a rotatable portion is rotationally coupled to the static portion. The rotatable portion includes an infrared sensor positioned to receive infrared light from the room through the first area of the outer shell and an imaging sensor, separate from the infrared sensor, positioned to receive visible light from the room through the second area of the outer shell. The apparatus also includes a motor arranged to rotate the rotatable portion with respect to the static portion, a processor coupled to the infrared sensor and the imaging sensor, and a communications interface coupled to the processor.

### CROSS-REFERENCE TO RELATED APPLICATIONS

This application is a continuation of International Patent Application PCT/2019/034054 filed May 24, 2019 which claims the benefit of U.S. Provisional Application 62/677,153 filed May 28, 2018, both of which are hereby incorporated by reference in their entirety herein for any and all purposes.

### BACKGROUND

### Technical Field

The present subject matter relates to monitoring a room using infrared sensors. More specifically it relates to using a rotating sensor to monitor the room and using that data to detect and react to various conditions in the room.

### Background Art

As the population ages, the ability to monitor the health and welfare of a person in their home is becoming increasingly important. There are many different ways of monitoring an individual in their home, from simple “Call Help” buttons worn or carried by the resident, to full coverage of an area using high-resolution visible-light cameras with night-vision. A simple button to summon help will not work if the individual is unconscious or otherwise unable or unwilling to ask for help, making it a less than ideal solution But the use of a camera can be seen as truly invasive, even if the images are not made available to any unauthorized individual. Even if a system could be designed which never sent an image from the camera to any human and was fully automated using artificial intelligence (AI) and machine learning, many individuals may still feel like that camera lens in their home is invading their privacy.

### BRIEF DESCRIPTION OF THE DRAWINGS

The accompanying drawings, which are incorporated in and constitute part of the specification, illustrate various embodiments. Together with the general description, the drawings serve to explain various principles. In the drawings:

FIG. 1 is a stylized view of an embodiment of a system to monitor a room;

FIG. 2A and 2B provide different views of an embodiment of a room monitoring apparatus;

FIG. 2C shows a detailed view of a portion of the embodiment of the room monitoring apparatus of 2A/B;

FIG. 2D shows a stylized cross-sectional view of the embodiment of the room monitoring apparatus of 2A/B;

FIG. 3A and 3B provide different views of an alternative embodiment of a room monitoring apparatus;

FIG. 4 is a representation of an embodiment of a single-column infrared sensor;

FIG. 5 shows how a panoramic image of a room containing an embodiment of the room monitoring apparatus may be created;

FIG. 6 shows an example low-resolution infrared image created by the room monitoring apparatus;

FIG. 7A and 7B show examples of stick figures that may be extracted from low-resolution infrared images by an embodiment of the room monitoring apparatus;

FIG. 8 is a block diagram of an embodiment of the room monitoring apparatus;

FIG. 9A and 9B show flowcharts of embodiments of a method for use by a room monitoring apparatus; and

FIG. 10 shows a flowchart of an embodiment of a method for use by a remote computer in communication with a room monitoring apparatus.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification.

An intelligent monitoring and communication system for a smart home and assisted living is disclosed herein. The system includes an internet-connected in-home monitoring device, which may be referred to as “Skypod,” and cloud-based computing elements, as well as using human agents. The design philosophy of this system has a very strong emphasis on privacy, while being very capable of detecting potentially life-threatening situations for the resident and alerting appropriate caregivers to respond. The Skypod device and associated system provide a reliable and cost-effective monitoring solution for a smart home, including dignified assisted living arrangements.

Skypod accomplishes this by using a locally hosted AI system to monitor indications of dangerous situations or medical anomalies via a low-cost, relatively low-resolution, infrared imaging system, without a visible traditional camera lens constantly watching, and without incurring the risk or expense of passing private video streams to cloud for analysis. The spatial resolution of the infrared imaging system is selected to avoid being able to recognize a particular individual or specific details of an individual's activity, state of dress/undress, or other details which may be considered an invasion of privacy, but high enough to make an initial determination of a potentially dangerous situation, such as unnatural body positions, being prone in an unusual place for an extended period of time, abnormal body temperatures, an unexpected number of people in the room, or other situations that may threaten the health and safety of an individual.

While the Skypod does include a high-resolution visible light/near-infrared(NIR) camera and microphone array, the lens of the camera is covered during normal monitoring and the system incorporates a privacy-minded escalation procedure that seeks explicit or rule-based implicit consent before passing encrypted microphone audio and high resolution camera streams to a cloud-based resource for escalated response through designated, trusted “Guardian” caregivers or professional care providers.

The Skypod device is a network-connected electronic device designed to be easily mounted on a ceiling within a room in a home, apartment, assisted-living center, nursing home, hospital room, or other room where it may be valuable to monitor a person or persons without invading their privacy. It may be battery-powered or mains-powered, depending on the embodiment and the installation. The device may be designed to look very similar to a smoke detector or carbon monoxide (CO) detector, and in some embodiments may include that capability. The Skypod device includes a pair of imaging subsystems. One is a low-resolution IR (“thermal” infrared) lensed line array or grid sensor with a wide vertical field of view and the other is a high-resolution, conventional multi-megapixel NIR+RGB (near-infrared and visible light—red, green, blue) camera. Both imaging systems are arranged to cover about the same vertical field of view and are pointed in about the same azimuth direction from the device. In some embodiments, both imaging systems are mounted on an imaging carriage that can rotate under control of a processor within the device around a vertical axis of rotation. The visible-light camera has a mechanical privacy shutter to physically block it from capturing images while not in use, and perhaps even more importantly, to hide the camera lens from view to provide a sense of privacy to individuals in the room. In some embodiments, the Skypod also includes a microphone array with an associated digital signal processor (DSP) that can analyze and enhance the microphone signals, and an amplified loudspeaker for telephony and communication purposes.

During normal monitoring, the revolving imaging carriage is swept around continuously or periodically, capturing an infrared (IR) image of at least a portion of the room. Depending on the characteristics of the particular IR sensor used, the IR image may be a series of individual images captured by the sensor, or the IR image may include a panoramic image created by compositing multiple images captured by the IR sensor at different azimuth angles into the panoramic image. In some embodiments, the IR sensor may include only a single column of elements, so that the IR image is created by capturing individual columns at discrete intervals as the imaging carriage rotates.

Once the IR image has been captured/created, onboard AI may discern human forms and situational data from IR image(s) and look for anomalous situations. If it is determined that a potentially anomalous situations exists, warranting deeper investigation, the IR image(s) are sent to cloud-based AI for further analysis. The cloud-based AI agent can apply a much higher level of computing resource to the analysis than can be applied within the Skypod device itself, allowing it to provide a more accurate analysis of the IR image(s). If the cloud-based AI recognizes an urgent situation or a possible medical emergency, it can initiate an escalation procedure that may include a variety of responses including, but not limited to, capturing audio from the room to determine if additional information about the situation can be ascertained, sending an audio message to the user asking for confirmation of their well-being and listening for a vocal response, directly summoning emergency responders, or seeking explicit or rule-based permission to establish an interactive audio/video (AV) session with a designated caregiver using the microphone, speaker and visible-light camera included in the Skypod device.

One non-limiting use case for the system described herein is for an assisted living monitoring service. In such as environment, a Skypod device may be mounted on a ceiling or wall in one or more rooms where the individual being monitored (i.e. a subject) spends their time. The Skypod then autonomously provides low-level/first-tier situation monitoring by watching the low-resolution thermal IR images and looking for anomalies. The monitoring service can provide an escalation mechanism where individuals that have been specifically designated by the subject (herein sometimes referred to as “guardians”), such as family members of close friends, and/or professional care providers are conditionally alerted to possible trouble situations and can interact with the monitored subject through voice and video communication.

In such an application the Skypod may be put into one of several states. Table 1 provides one non-limiting example of potential states of the Skypod device

TABLE 1

| State | Description |
|---|---|
| Disabled | The device provides no monitoring of the subject, although other sensor |
| | functions, such as smoke-detection or CO detection, may remain active. |
| Subject- | The device is in the disabled state until it receives an explicit indication |
| Activated | from the subject or other agent (e.g. a guardian, an automated agent responding |
| | to another situation outside of the monitored room, or other human/automated |
| | agent) that it should begin monitoring the subject. Examples of explicit |
| | indications from the subject that may be used to initiate monitoring include, |
| | but are not limited to, pressing a button on the Skypod or other device, |
| | speaking a predefined wake word, or using a mobile app on a mobile device. |
| Motion- | The device may be in a low-power state (to save on battery power, for |
| Activated | example) until a motion detector included in the Skypod (different than the IR |
| | sensor and visible light camera) detects motion in the room. |
| Non-intrusive | IR images are captured and analyzed by the onboard AI system in the Skypod |
| Monitoring | device to determine whether a hazardous situation may exist before escalation |
| | to a cloud-based resource. This may be referred to as the “normal” |
| | state of the device. |
| Alert | The onboard AI has determined that a trouble situation may be occurring, with |
| | a confidence level exceeding set threshold, resulting in communication with an |
| | entity outside of the Skypod device, reducing the subject's privacy to some |
| | extent. In this state, the cloud-based image analyzer has access to IR imagery. |
| | The Skypod device may not provide any indication of heightened activity in |
| | this state and in at least some embodiments, no humans are involved in this |
| | state. |
| Concern | This state is entered if the cloud-based image analyzer AI concurs with the |
| | device-internal AI that a trouble situation may be occurring. Escalation to |
| | human caregivers may be initiated using an account-defined priority order of |
| | escalation or dynamic selection based on actual proximity of approved |
| | guardians determined using location services to determine the current location |
| | of the guardians. In some embodiments, an attempt to obtain explicit approval |
| | for escalation from the subject may be made before entering this state. |
| Alarm | This state is entered when it is determined that a guardian or other enabled |
| | caregiver should be given access in order to more accurately evaluate the |
| | situation. It may be entered automatically based on pre-determined rules and |
| | the AI evaluation of the IR images (either onboard or cloud-based) and/or by |
| | an explicit request or approval by the subject. In this state the guardian or |
| | other caregiver is given full access to camera and bi-directional audio using |
| | the Skypod device and in some embodiments they may be given control of other |
| | smart home or internet-of-things (IoT) devices such as lights or door locks to |
| | provide access or improved conditions for on-site responders. |

The system may also include designated privacy levels that may interact with the device state levels. In some embodiments, the privacy levels are allowed to track the state levels as appropriate, but in other embodiments, the privacy levels may be set by the subject or other individual to limit the capabilities of the system. In some cases, the privacy levels may interact with parameters from the onboard or cloud-based AI system to determine whether the system is allowed to change to a lower level of privacy. Examples may include requiring a certain level of confidence that the hazardous situation exists, or having different privacy reduction policies based on different potential hazards. Table 2 shows a non-limiting example of different privacy levels that may be implemented within a Skypod device.

TABLE 2

| Privacy Level | Description |
|---|---|
| High | Privacy is strongly maintained. No audio, image, or video information is sent |
| | outside of the Skypod device and the lens of the camera is kept hidden behind a |
| | shutter of the device. All situational analysis happens locally, inside the Skypod |
| | device. In some situations, general environmental information, such as |
| | temperature, humidity, noxious gas levels, or other data unrelated to the subject |
| | themselves may be used to trigger alarms, however, similarly to a standard |
| | smoke alarm. This privacy level is maintained in the first three device states |
| | defined in Table 1, but the Alert, Concern, and Alarm state require a lower level |
| | of privacy. |
| Medium-High | At this privacy level, IR images from the IR sensor are allowed to be sent |
| | outside of the Skypod device to non-human agents, but audio and images from |
| | the high-resolution camera are not. The images are also not to be made |
| | available to human agents, including designated guardians or caregivers while |
| | in this privacy level. Audio from the Skypod may also be made available to |
| | cloud-based AI agents, but not to humans. The Alert state requires this privacy |
| | level (or lower) in order to function. |
| Medium | At the medium privacy level, viewing of the IR images from the IR sensor may |
| | be viewed by designated guardians or caregivers in addition to allowing |
| | analysis by cloud-based AI agents. Human agents are not given access to audio |
| | captured by the Skypod at this privacy level. At least some capabilities of the |
| | Concern state may be utilized at this level of privacy. |
| Medium-Low | Access to the audio resources of the Skypod is opened up at this privacy level. |
| | This allows a designated guardian to attempt to initiate a two-way voice |
| | communication with the subject, as well to use any sounds captured, such as |
| | screaming or moaning, to help evaluate the situation. The Concern state can be |
| | fully utilized at this privacy level. |
| Low | This is the lowest level of privacy. If this privacy level is allowed, the Alarm |
| | state may be used which gives a guardian or authorized caregiver full access to |
| | the monitoring capabilities of the device, including high-resolution visible light |
| | or near-infrared images and full two-way audio communication. |

As is outlined above, the Skypod device is an area-monitoring and communication device which provides monitoring and communication functions for use in human-occupied areas (e.g. rooms) within any premises. Using wired or wireless communication channels (including the internet) the Skypod is may be connected to a remote computer system, which may be within the premises or at any remote facility worldwide (including cloud-based resources), and which may provide access by authorized entities to information that is made available through the Skypod's functions. The Skypod may receive its operating power from internal batteries, from low-voltage (<48V) DC or AC sources, or from mains power (e.g. 120 VAC or 240 VAC), as may be available in the premises. The Skypod supports monitoring of an area, including its ambient environment and its occupants, at preauthorized privacy levels with respect to the occupants, by entities with authority to access the Skypod.

A Skypod can provide basic monitoring by passive-infrared (PIR) detection, and escalated monitoring using other sensors, such as by a visible/NIR-wavelength camera or a light detection and ranging (LIDAR) sensor, either one of which may be considered an imaging sensor. Additionally, a Skypod device may include other sensors to report air temperature, effective radiated temperature, relative humidity, ambient light level, volatile organic compound (VOC) concentration, and the like. A Skypod device may also include communication functionality to provide two-way audio communication between an occupant and another party or using other signaling devices, such as indicator lights, displays on the Skypod device of coupled to the Skypod device (e.g. a device coupled to the Skypod using Bluetooth® that allows a textual message to be displayed, or a device that displays an image on the television in the room).

The monitoring and communication may be governed by a predetermined minimum privacy level of a privacy level that is changed based on predetermined rules. In some embodiments, usage rules which may be negotiated among users (i.e. area-occupying humans and other entities with remote access to the Skypod) may be used to govern allowable uses of the Skypod. Rules may include basic pre-agreed protocols that in turn may additionally include provisions for real-time privacy level negotiation between the occupants being monitored and other entities receiving the information from the Skypod. In addition, some rules may allow for overriding predetermined privacy levels or other rules based on a variety of other factors, including, but not limited to, the occupant's inability to communicate (e.g. due to injury or unconsciousness) or a well-established life-threatening situation (e.g. a fire).

Some embodiments of a Skypod device may also include user interface functions (e.g. buttons, indicator lights, knobs, touch-screens, or the like), components for providing room lighting, components for providing lighting within the field of view of a visible/NIR-wavelength camera, or any number of other components/functions as are appropriate for a particular embodiment.

The Skypod's occupant-monitoring aspect detects and reports human occupancy, occupant disposition and environmental conditions. The monitoring includes PIR sensors which may include (yet are not limited to) a PIR Scanner and/or a PIR Motion Sensor.

In some embodiments, monitoring may include a PIR Scanner that functions to provide information about human occupants and about environmental conditions in a monitored area. A scan may be performed at regular intervals in order to determine, by comparing successive scans, if persons are moving within the monitored area. A two-dimensional scan may be supported first by arranging for IR radiation from a narrow, quasi-vertically-oriented field of view within the monitored area to be directed by lenses, mirrors or other optical elements onto an array of IR sensing elements that are oriented along a line. Each sensing element thus receives and can report IR radiation measured from a small vertical section of said field of view, such that radiation from the entire quasi-vertical field of view is received from the total number (or set) of sensing elements in the array.

Each small vertical section may be regarded as a field of view or “pixel”, with each pixel reporting the radiation measured by one IR sensing element, onto which radiation is incident from a certain section of the narrow, quasi-vertically-oriented field of view within the monitored area. To generate a two-dimensional scan, optical elements and/or the line-array detector may be periodically moved so as to enable collection and measurement of radiation from additional quasi-vertically-oriented field-of-view (pixel) sets at various azimuthal angles relative to the Skypod. Said field-of-view (pixel) sets may be horizontally adjacent to one another. By recording the radiation from these pixel sets as elements move, a composite two-dimensional scanned “image” can be developed over any angle up to 360° (degrees). Other embodiments may employ a two-dimensional IR-detector array, which may not in itself support larger scan angles, yet which can be used to capture adjacent or overlapping images at various azimuthal angles as it is rotated and the images stitched (i.e. composited) together to create a panoramic image of up to 360. Again, as with the line-array IR detector, by recording these pixel sets as the optics and/or detector move to measure radiation from pixel sets at various azimuthal angles relative to the Skypod, a composite image can be developed over any angle up to 360 degrees.

IR detector arrays require some power in order to operate their multiplexing, amplification and signal-processing functions. In order to conserve power in battery-powered embodiments, and to conserve the service life of mechanical parts, in some embodiments, occupant movement within the monitored area may be determined using low-power devices, such as a PIR motion sensor. Such a sensor requires much less power than a PIR scanner, and can cover a large monitored area. Furthermore, a PIR motion sensor can respond quickly to motion, without the latency of a scanning-time interval which may require physically moving the sensor. However, the sensor's output is typically limited to a simple one-bit digital signal (indicating motion or lack of motion) or to a simple analog signal. A PIR motion sensor cannot provide more advanced functions which may be derived from PIR scanner images, such as occupant disposition or number of occupants.

Given the complementary characteristics of PIR motion sensor and PIR scanner, another embodiment of the Skypod's basic monitoring includes both functions. In this embodiment, the PIR motion sensor indicates occupants' major motions (say, of one step, or of a half-meter body movement) and degree of occupants' major activity within the monitored area. In this embodiment, the Skypod may conserve energy by entering a sleep mode whenever non-occupation of the monitored area is determined from information provided by the PIR motion sensor and PIR scanner. A person entering the monitored area can be detected by the PIR motion sensor, and Skypod functions can awaken.

Upon Skypod “wake-up”, and afterward, from time to time, or, for example, when the PIR motion sensor reports a comparatively low activity level in the monitored area, the PIR scanner may perform a scan and generate a somewhat low-resolution mid-infrared (IR) image of the monitored area. As persons usually radiate IR radiation differently from that radiated by surfaces and objects in the monitored area, shapes representing occupants are evident in the scan's recorded pixel sets, and may be evaluated for general disposition of an individual, number of individuals present, and the like. The low spatial resolution is chosen so as to avoid the loss of privacy that people typically associate with ordinary (visible/NIR-wavelength) cameras. The image may be analyzed either locally or in a remote computer, for a variety of purposes, including, as not limiting examples, lighting/climate control in the room, as well as for assessing and indicating occupant disposition to caregivers, family members and/or other authorized parties that may be given access to the information from the Skypod through a remote computer. For example, if the PIR motion sensor and PIR scanner both report no human presence in the area, then the remote computer may de-activate lighting and adjust climate-control to an unoccupied setting. Alternately, if the PIR motion sensor and PIR scanner determine the presence of several human occupants, the remote computer may activate lighting and adjust climate control to compensate for a high-occupancy condition which may merit increased air circulation or slightly cooler temperature than for a single occupant.

The PIR motion sensor may operate via a dedicated lens array or cover (designed not to resemble in any way a “seeing” device such as a camera lens) on the Skypod, or via the Skypod's opening (an opening in the housing, which may be fitted with an IR-transparent/visible-light-opaque cover (provided as proof to occupants that no visible/NIR-wavelength camera lens can “see” outward). The PIR scanner may operate via portions of the Skypod's housing that are made from IR-transparent/visible-light opaque material. Alternately, the PIR scanner may operate via the Skypod's opening, through the cover. The Skypod may control the cover so that it at times may cover the opening or at other times be moved away from the opening. With the cover covering the opening, The Skypod can support all but the lowest privacy level described in Table 2.

Low-resolution image information may be used as a basis, for example, as evidence of a medical emergency (e.g. a monitored-area occupant in a prone position and not moving) to escalate the device state to a level (i.e. the Concern state) which allows authorized entities to be notified and prompted to assess low-resolution images and to initiate, and/or if deemed advisable, escalation to the Alarm state. A variety of predetermined rules set by the occupant(s), predetermined guardians, and/or caregivers, as well as the predetermined minimum privacy level, may be used to escalate the device state and/or change a current minimum privacy level.

The PIR-scanner image may also be used to monitor environmental conditions such as wall and floor effective-radiated temperatures, hazardous “hot spots” such as overheated electrical outlets, and the like. The Skypod may be further fitted with various sensors to monitor other environmental conditions such as smoke, CO level, temperature, relative humidity, ambient light level, volatile organic compounds (VOC), combustible gases, and so on.

The Skypod also allow its bi-directional voice interface to be used with generally available voice-interface services, such as, but not limited to, Amazon's Alexa™ or Google Assistant™, as well as with specific provider services, such as eldercare aging-in-place management, hotel-room management or general home management, any of which may be privately linked to the Skypod. The bi-directional voice interface may also be used with voice communications services such as those offered by Microsoft's Skype or Facebook Messenger as well as with conferencing services such as Zoom® or Cisco's WebEx . The voice interface can provide two-way communication between monitored-area occupants and caregivers, family members and/or other authorized parties that may be in contact through a remote computer. The voice interface may include input signal-processing for optimum clarity and direction-finding, as well as an output transducer such as a loudspeaker. Audio privacy may be controlled by market-available voice-interface service (e.g. by audio activation only upon receipt of a “wake word”) and/or controlled by the Skypod as governed by such privacy levels as are mentioned above. The Skypod may also provide audio processing features such as ambient-noise reduction, echo cancellation, and the like. Additional features may include multiple-microphone beam-forming to allow further noise reduction and to determine the azimuthal angle, relative to the Skypod, of sound origination. The Skypod may also include audio-output transducers such as loudspeakers or other devices as well as appropriate amplification of the audio signals to drive the selected transducers.

Due to the Skypod's typical installation at elevated position within a monitored area, some embodiments may include area-lighting features (particularly in situations where the Skypod is installed over an electrical box in lieu of an existing lighting fixture). In cases where mains power to the electrical box is controlled by a switch, a smart switch may be installed, which may always convey power to the Skypod, yet which may allow a user to turn the light on and off by communication between the smart switch and the Skypod or by providing control of the light through a home network through use of an app on the user's smartphone. The Skypod's light may also be controllable by through the remote computer as well, in particular, at least for the case of providing lighting for the visible/NIR-wavelength camera. Notably, in order to provide minimum distraction to occupants during visible/NIR-wavelength camera activity, two separately-controllable lighting channels may be provided in some embodiments, one that provides illumination of the room, and one that provides NIR light for the visible/NIR-wavelength camera. As a lower-energy alternative (or a supplement) to area-wide lighting, directional visible and/or NIR lighting may be provided into the movable visible/NIR-wavelength camera's field of view by light sources that are co-mounted with the Camera.

The Skypod's exterior may a housing (e.g. an outer shell). Depending on the embodiment, the housing may be shaped in any way, including, but not limited to, a cylindrical or rectangular-prism shape, ceiling-mounted in a similar manner as with a lighting fixture, a rectangular-prism or half-cylindrical shape, wall-mounted, or a triangular-prism or quarter-cylindrical shape, wall-corner mounted; all with some portion essentially facing the area's floor and walls (if present) and with an “opening” that mates with a visible-light-opaque In at least one embodiments, the Skypod may be designed to look like a conventional smoke alarm.

The Skypod may include a cover that may be moved under Skypod's control to cover or not to cover the opening for the camera. In some embodiments, the camera may receive infrared light through a portion of the housing that is transparent to visible/NIR light instead of an opening in the housing. The cover may be made from a single piece of material and lie normally in one position, held by gravity or a spring, and be connected to an arm or shaft that can lift the cover upward or sideways to open or close the cover. In some embodiments the cover may include two parts that act as a shutter to cover or expose the camera. In another embodiment the cover may have multiple elements with an iris design as frequently found in camera shutters and lens protectors. Any type of mechanism can be used as the cover to both block/expose visible/NIR light from the room reaching the camera and to provide a highly-visible privacy indicator to show the user that they are not being monitored by a high-resolution camera. The Skypod may include, adjacent to and just within the covered opening, a surround of brightly-colored and/or highly contrasting material that becomes visible to occupants whenever the cover is open to allow an occupant to see that the camera is exposed and may be in operation. The Skypod may also include additional mechanisms to alert occupants of camera activation, including, but not limited to, a visible indicator lamp near the camera or an audible sound.

A Skypod device includes one or more of several spatial-monitoring functions, including one or more of a simple PIR motion sensor to report occupant motion within the monitored area, a microwave-based motion detector, a PIR sensor (e.g. a mid-IR line-array or two-dimensional-array detector) that can monitor the area through an area of the Skypod's outer shell that is transparent to mid-IR radiation without looking like a camera, and a visible light camera which may also be sensitive to near-IR light.

The PIR sensor may be used with a scanning functionality to create an image that is larger than is provided directly from the PIR sensor. There are many possible ways of causing movement of optical and IR-sensing elements so as to realize a scan as described above. One non-limiting embodiment uses a fixed combination of IR-detector and optics that can be rotated 360 degrees on a carriage that surrounds an opening in the outer shell. The detector and optics are oriented to receive their respective radiation throughout a rotation of the carriage through a ring of IR-transparent material in the outer shell.. Thus, a 360-degree scanned image of the monitored area can be developed by rotating the detector and optics on the carriage. In another embodiment, the PIR sensor may be fixed to a portion of the outer shell that is rotated with the PIR sensor with the sensor receiving IR radiation through an area of the rotating portion of the outer shell that is transparent to IR light. In another embodiment, the IR sensor may be mounted on the carriage to receive light through the same opening as the visible/NIR camera. The cover for that opening may be made of an IR-transparent material to allow the IR sensor to operate without opening the cover.

In addition to the IR sensor, a visible/NIR imaging sensor (e.g. camera or LIDAR module) may also be mounted on the rotating carriage. The camera may be mounted in a different position than the IR sensor on the carriage so that, when no IR scanning motion is in progress, the cover may be opened and the camera may be rotated to capture an image of a selected portion of the monitored area based on the azimuth of the carriage. In some embodiments, a visible and/or NIR light source, aligned with the camera's directional axis, may be included illuminate objects within the camera's field of view if activated by the Skypod due to low ambient-light level. Other devices which may be mounted on the rotating carriage in some embodiments include, but are not limited to, a highly-directional microphone and a microwave transceiver for remote detection of small motions (e.g. a heartbeat).

In other embodiments, the visible/NIR camera may not be mounted on the rotating carriage but may be positioned elsewhere on the Skypod. In such embodiments, the camera may be fitted with a wide angle “fish-eye” lens to allow the entire room to be captured in a single frame. The lens may be extended when the cover is opened to allow an image of the entire room to be captured or a cover that extends to cover the protruding portion of the lens may be used. In another embodiment, the visible/NIR camera may be mounted on the Skypod to allow remote control of its pan, tilt, and zoom (PTZ) as is common for security cameras, while still using the rotating design for the PIR sensor.

The carriage may be internal to a stationary outer housing, or it may include a rotating (lower) portion of the outer housing itself. The carriage's rotation may be realized with a single movement-bearing part (e.g. a ball-bearing assembly at a center-axis location on the carriage), or by various other bearings distributed along circumferences of carriage features. Alternately, the carriage may be suspended by one or more torsion members that are coaxial to the carriage's rotation. Drive for the carriage's rotation may be provided by any of various types of motors; position-sensing may be provided by an optical rotation encoder, for example, based on Gray code or on a quadrature encoder with an index sensor.

As mentioned earlier, a variety of power sources may be used for various embodiments of a Skypod device. Since that power source is likely connected to a static portion of the device that is mounted on the ceiling (or other surface in the room), power may be provided to the rotating carriage by a different mechanisms for different embodiments. Some embodiments may convey power via a flexible cable, via slip-rings, or via contacts or coils that are aligned when the carriage is positioned at a particular azimuth direction. In some embodiments, the rotating carriage also includes an energy storage device which can be charged by the contacts or coils. While the contacts/coils may be aligned at only a single azimuth position, this may be a majority of the time as in some embodiments, the carriage is only moved after motion is detected which may not occur for long periods of time. And in some embodiments, an image may only be acquired periodically from the IR sensor, meaning that the carriage can spend time between scans at the azimuth angle which aligns the contacts/coils. the (which, in actual application, may be most of the time—while the Skypod is in simple PIR-motion-sensor operation). Energy storage for powering carriage-mounted devices may be provided, as non-limiting examples, by a rechargeable battery or by a large capacitor.

A variety of communication interfaces may be provided in different embodiments of the

Skypod to provide for communication with other devices. In some embodiments the Skypod may optionally provide for communication with local devices using one or more radio-frequency or optical protocols, including, but not limited to, Bluetooth, IEEE 802.15 compliant protocols such as Zigbee® or 6LoWPAN, Z-Wave, protocols from the Infrared Data Association (IrDA), and consumer IR remote-control protocols. A Skypod may include one or more local area network (LAN) or wide area network (WAN) communication interfaces, which may be wired, optical, or wireless, to allow the Skypod to communicate with a remote computer. Non-limiting examples of a network interface that may be included in a Skypod device include an Ethernet interface (including wired or optical), an IEEE 802.11 interface (i.e. WiFi®), a 4G or 5G cellular data interface, an IEEE 802.16 interface (WiMAX™), and a multi-media over coax (MoCA) interface. In some embodiments, a network interface using power-line networking such as HomePNA may be included in the Skypod.

In battery-powered wireless embodiments, in order to conserve battery energy and thus reduce the frequency of battery replacement or recharging, the Skypod may have one or more standby quiescent modes of micro-power operation. Such a quiescent mode may be supported by, for example, a micro-power PIR motion sensor which may require as little as a few tens of microamperes to operate. The PIR motion sensor may be controlled by a low-power microcontroller that is operating at a very low duty cycle for a net average current draw also on the order of tens of microamperes. Meanwhile, the PIR scanner, which may be a relatively low-power device itself, may be kept in a micro-power standby mode except for an occasional several-second-long scan that is initiated by the microcontroller based on appropriate criteria such as movement, lack of movement, occupancy and various ambient conditions.

Low-resolution images from the PIR scanner may be stored and/or analyzed either in the Skypod itself or in a remote computer. Thus, in some instances, the PIR image may show a human occupant in a disposition that might be perceived by the Skypod or remote computer as differing from usual dispositions. Examples of this may include, for example, an occupant lying in an unusual location on the area floor or having an unusual posture for an extended period of time. The remote computer may report such a situation to predetermined guardians or authorized caregivers and change to a device state to permit them to consider appropriate actions, such as viewing the low-resolution images and deciding if the occupant may be in distress or in need of assistance.

Particularly in situations of distress, the Skypod's other features may come into play. In a battery-powered embodiment many of the components supporting those features, such as the high-resolution visible/NIR camera, audio and video processors, and audio amplifiers may be kept unpowered or in micro-power standby mode until activated by local or remote decisions (based on information provided by the PIR motion sensor and/or PIR sensor) to escalate Skypod functionality by activating additional devices.

For example, bi-directional voice Communication may enable caregivers, having been alerted by an alert from the remote computer on their smartphone, to engage in conversation with the occupant in order to ascertain if help is needed, or if the unusual disposition identified by the remote computer is simply an anomalous event. Bi-directional voice communication may enable caregivers to request permission from the occupant to lower their previously set privacy level to allow high-resolution visible/NIR images to be sent to the caregiver in order to enable a more-detailed situational assessment. Camera orientation may be determined by the various azimuthal and elevation information provided by the PIR scan, the voice-communication system's microphone array, and the camera image itself. In order to provide clear images illumination of the field of view of the camera may be enabled using the Skypod's area lighting or directional light source that is aligned with the camera's directional axis.

In cases of an unresponsive occupant, previous agreement with the occupant could automatically grant permission to open the cover and to activate camera and lighting. Some embodiments of the Skypod could use of the highly-directional microphone array to capture sound from the occupant's location, and/or use the microwave transceiver for detection of very small motions (including the occupant's heartbeat).

Reference now is made in detail to the examples illustrated in the accompanying drawings and discussed below.

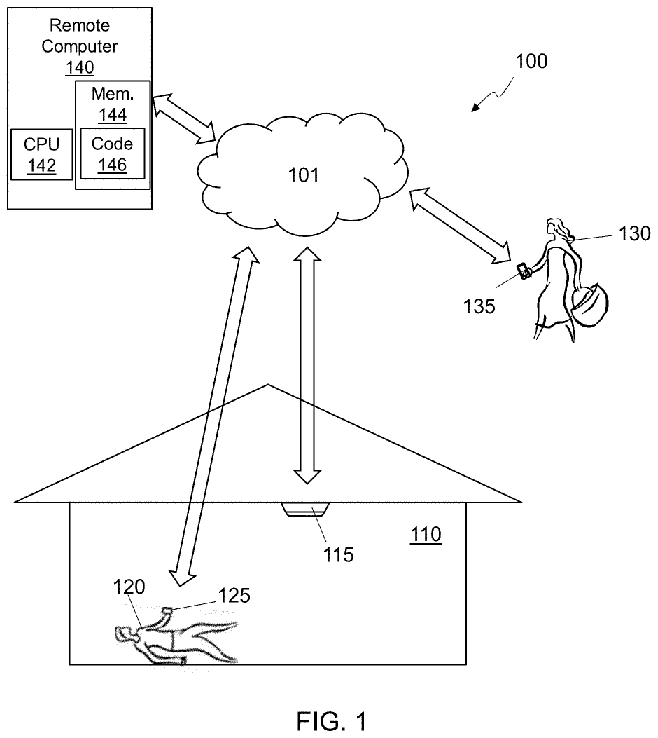

FIG. 1 is a stylized view of an embodiment of a system 100 to monitor a room 110. The system 100 includes one or more room monitoring apparatus 115 (e.g. a Skypod device as described herein) and at least one machine readable medium 144 comprising one or more instructions 146 that in response to being executed on the remote computer 140, using the processor 142, cause the remote computer 140 to carry out a method that includes receiving a two-dimensional image from the apparatus, analyzing of the image to ascertain whether the first image shows a person 120 in a position that indicates the person may be in distress, determining whether to escalate to a human agent 130 based on the analyzing, sending a command to the apparatus to capture an image of the person based on the determination, and receiving that image of the person. In embodiments the remote computer 140 may be a single computer or a group of computers that can perform various tasks of the method. The remote computer 140 may also be referred to as a cloud-based computer or resource.

The apparatus 115 may include a processor which is configured to receive information from an infrared sensor and form a two-dimensional image utilizing the information. The processor may analyze the two-dimensional image to determine whether to send the two-dimensional image to a remote computer through a communications interface of the apparatus, and send the two-dimensional image to the remote computer through the communications interface based on the determination. The communications interface may be configured to utilize radio frequency communication to communicate with an entity outside of the apparatus, and the processor may be configured to communicate with a cloud-based resource 140 through the communications interface. In addition, the processor may be configured to receive a command through the communications interface, move the rotatable portion of the apparatus 115 to a designated position based on the command, receive an image from the imaging sensor, and send the image to a remote computer 140 through the communications interface.

The system 100 may also include or utilize additional elements including the use of the internet 101 or other computer network or set of networks to allow the devices of the system to communicate with each other, and other devices, such as a mobile device 135 of the guardian 130 or caregiver, and a mobile device 125 of the subject 120, both of which may be smartphones. The system may include computer readable memory with instructions for methods that may be performed on the smartphones 125, 135 which may include enabling interaction with the devices located within the apparatus 115 to receive low-resolution IR images, high-resolution visible light images, high resolution IR images, audio, or other environmental information, as well as enabling communication between a human agent 135 (or AI agent) with the subject 120. Any number of other devices may also be included or used by the system 100, including additional remote computers, other computers or electronic devices used by a guardian 130, caregiver, or subject 120, IoT smart home devices such as smart light bulbs and switches and door locks, and other devices of any type. In some embodiments, the apparatus 115 may include a light source suitable to provide illumination for the room 110 and controllable by a user 120. The control of the light source may be by any suitable mechanism, including a wall switch, a control on the user's phone 125, or voice control, and the light may also be controlled by the remote computer 140 in some embodiments.

The system 100 may provide for access to data from the apparatus 115 for caregivers or guardians 130 of the subject 120. In some embodiments, dependent upon the access privileges designated for the individual 130, the system 100 may send low-resolution IR imagery, high-resolution imagery, or audio data from the apparatus 115 to the individual 130 in real time by relaying encrypted AV session streams with low latency from the apparatus 115 to/from the individual 130 as warranted by a particular escalation situation and permissions granted by the subject 120 for the individual 130. The system 100 may also provide access to stored historical of any of those data types. In some embodiments, the system 100 may allow the individual 130 to control the position of the rotatable portion of the apparatus 115 to select the view of the camera and may also allow for controlling a zoom level (optical or digital). The system 100 may also enable two-way audio communication between the subject 120 and the individual 130 as well as provide for control of IoT devices in the room 110 by the individual 130.

The remote computer 140 may also provide image analysis using AI and a heuristics engine to determine whether the subject 120 is threatened or in distress. The image analysis performed by the remote computer 140 may be more thorough and accurate than that performed within the apparatus 115 due to the much greater computing resources available in the cloud as compared to the individual apparatus 115. In addition to performing the image analysis on the low-resolution IR imagery, the remote computer may be able to perform image analysis on the high-resolution imagery to provide even greater accuracy in predicting whether the individual 120 is in distress. Having the remote computer 140 perform a second and potentially more accurate analysis of the situation based on the imagery available from the apparatus 115, before escalation session to human caregiver 130, may significantly reduce the cost of care as well as minimize intrusions into the subject's 120 privacy.

Various other tasks may be performed by the remote computer 140 based on the code 146. Some embodiments, may include a variety of core functionality for the system, such as allowing a user or caregiver 130 to create a user account for a subject 120 and populate user information such as physical address, billing information, information on authorized guardians, as well as a link to records storage for that account and notes as well as any other information related to that account. The account may also enable one or more room monitoring apparatus 115 to be associated with the account. Information about where the apparatus 115 is mounted, desired privacy levels and rules for lowering of the privacy level and their interaction with the apparatus state, default rules and policies to apply for the subject of the account in the absence of rules and policies for a particular caregiver/guardian, and any other information or settings related to the device may also be entered into the account.

A list of potential caregivers (or caregiver agencies) registered with the system may be used to select which caregivers or caregiver agencies are authorized to interact with the system 100. The list may include caregiver information, such as name, contact information, employer, licensure information, and the like may be entered into the system by the caretaker, their employer, the account holder, or obtained from other sources, and stored in the account. Credentials (e.g. passwords, smartcard information, and the like) for caretakers to use for authentication of IoT access requests such as control of lights, door lock, and the like may be stored and associated with both the account and the caregiver. Rules and policies can be entered for particular authorized caregivers or caregiver agencies which may provide a blanket policy for any caregiver employed by that agency rather than requiring full information to be created for each potential caregiver of a pool of caregivers.

The system may also allow the creation of guardian accounts and the ability to link those guardian accounts to a subject's account. The subject may be able to select friends or relatives as guardians and provide similar rules and policies for guardians as is done for caregivers. The system may allow the subject to provide a set of rules for how individual guardians are to be contacted which may include policies such as a ordered priority list for the selected guardians, use of location services or an incident type to select a guardian to contact, to name a few possibilities.

The rules and policies for caregivers may include such information as the type of access each individual caregiver or guardian are to be given to the data from the system. Examples of data to which access might controlled includes general real-time motion information, real-time low-resolution IR imagery, real-time audio from the monitored area, real-time high-resolution imagery (IR, visible, depth, or any combination thereof), or stored historical data of any of the preceding.

The computer program 146 running on the remote computer 140 may also provide standard or proprietary application programming interfaces (API) for controlling IoT devices. Such APIs may allow the apparatus 115 sensors to be used for occupancy sensing and imaging for other authorized applications, such as in a general smart home context to interface with digital assistants and other cloud-based services such as those provided through www.ifttt.com (IFTTT). These APIs may also be used for control of IoT and smart home devices, such as unlocking doors for first responders and guardians. The code 146 may also provide an API to interface with other systems, such as those that might be used by caregiver services, assisted living centers, and first responders. This API may be useful for managing the access of caregivers and other care of the subject 120 as well as for tracking of billable time and events.

The system 100 may also include a smartphone app for use by the subject 120, as well as for caregivers or guardians 130. The smartphone app may include code, stored on a computer readable medium that causes the processor of the smartphone 125, 135 to perform various methods described herein when executed. Although it is referred to as a smartphone app, the code may run on any type of device used by an individual to access the features of the system 100, including, but no limited to, a desktop computer, a tablet, a notebook computer, a wearable device (e.g. a watch), a television, a dedicated device, or any other type of electronics. Depending on the embodiment, the same smartphone app may be used by different stakeholders, or a different app, tuned to the needs of a particular stakeholder group, such as subjects, guardians, caregivers, or others, may be provided for that particular group.

The smartphone app may communicate with the remote computer 140 to access the features of the system 100, including to access the live imagery and or audio communication services of the apparatus 115. But in some embodiments, the smartphone app may provide for direct communication between the smartphone 125, 135 and the apparatus 115 using a personal area network such as Bluetooth, a local area network such as WiFi, a wide area network such as a 4G cellular network, or any other communication mechanism.

Access to any of the features and functionality of the system 100 may be provided by the smartphone app, depending on the embodiment. It may be used by a subject 120, caregiver, guardian 130, or others that are provided access to the system 100 to configure a room monitoring apparatus 115 and control the monitoring service provided by the system. It may also provide guidance in the initial setup of an account and the apparatus 115 including such things as setting up service subscription, providing address and other personal information, providing billing details, authorizing, selecting, and approving caregivers and guardians as well as defining access and delegation rules as well as caregiver/guardian prioritization and escalation policies. The app may also provide an interface to link the subject's account to other services, such as an Amazon account, a Google Account, an IFTTT account, or other accounts and may allow for configuration of the way those accounts interact with the information form the apparatus 115, such as using Amazon's Alexa as a voice interface or allowing IFTTT rules to be triggered by an occupancy sensor function.

The app may also provide access for real-time services, such controlling the state of the apparatus 115 and/or enable/disable particular services of the system 100. The app may allow a user to view real-time or historical imagery from the apparatus and to control different functionality of the apparatus, such as to control the azimuth of the rotatable portion. It may also allow a subject 120 to call for help, manually escalate a situation, and provide consent for escalation or other requests from a caregiver or guardian. The app may also provide an interface for 2-way audio communication or even 2-way video communication in some embodiments. In some embodiments the app may include demo functionality to let a user see how the system works and help a user become comfortable with the privacy features and what the low-resolution IR image can actually show. In addition, the app may also allow the user to receive and respond to service notification, pay their bill, respond to billing issues, see service provider policy changes, planned service interruptions, and other administrative services.

The app may also provide certain capabilities for guardians 130 and caregivers that are not available to a subject 120. This allows them to receive escalation alerts and follow up on them as well as to initiate courtesy checks on the subject 120 as appropriate from anywhere. The app may require the guardian 130 or caregiver to provide appropriate credentials and may allow them to indicate whether or not they are available for escalations. Responding to escalations may include watching imagery from the apparatus 115, accessing an event log or information about the subject 120, communicating with the subject 120 using 2-way voice communication through the apparatus 115, controlling the apparatus 115 to collect more imagery, or other actions while working within the privacy settings and rules created for them by the subject 120. The guardian may also be able to dismiss the alert after finding no serious threat or discomfort for the subject or escalate to another resource, such as a professional caregiver or a first responder and may be able to use the app to control lights or unlock doors in the room 110 for the people responding to the further escalation.

In some embodiments, a guardian 130 or caregiver, with appropriate permissions, may be able to unilaterally access the resources of the apparatus 115 to establish an interactive session with apparatus. This may be used to initiate a courtesy check and may include the ability to view real-time low-resolution IR imagery or even to direct capture of a high-resolution image. They may also be able to initiate a 2-way voice conversation to check on the subject 120. Other capabilities may also be available such as reviewing past imagery, reviewing logs in the system, and checking on the functionality of the apparatus 115. They may also be able to escalate to a professional caregiver service if the circumstances dictate such.

A guardian 130 may also be set up as a surrogate for the subject 120, allowing them to receive & respond to service notifications, get copied on monitoring service notifications sent to subject 120, and if appropriately entitled, respond on the subject's behalf about billing issues, and the like. In some situations a surrogate may have full access to the subject's 120 capabilities in the system 100.

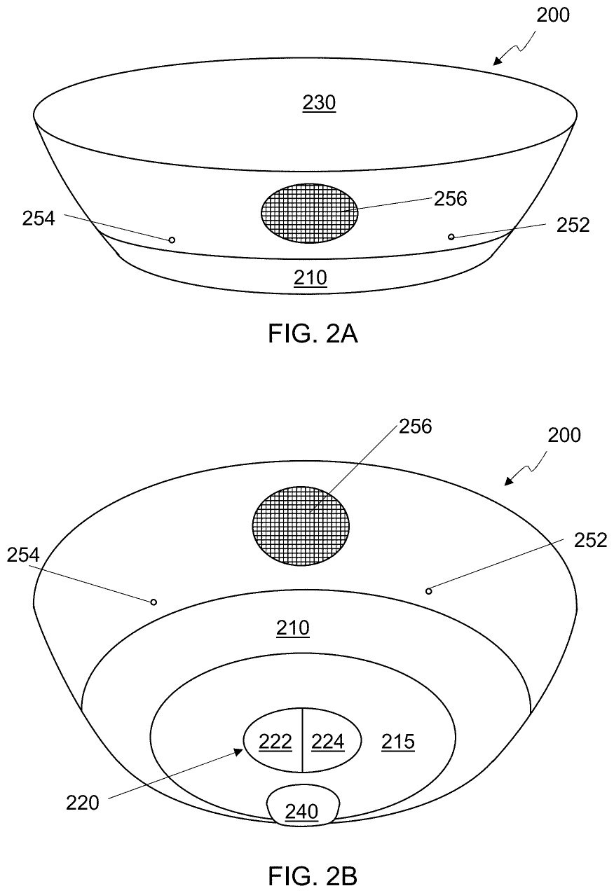

FIG. 2A and 2B provide different views of an embodiment of a room monitoring apparatus 200. FIG. 2A and 2B show different aspects of the apparatus 200 and as such, a single view cannot show each and every element mentioned. The room monitoring apparatus 200 includes an outer shell that includes a first area 210 transparent to at least some wavelengths of infrared radiation, a second area 220 transparent to visible light, and a third area 230 adapted to be positioned on a surface of the room. In some embodiments, the first area is transparent to mid-infrared light and the infrared sensor is sensitive to mid-infrared light. In the embodiment shown, the shell of the apparatus 200 has a ring 210 around its perimeter made of IR transparent material, such as high-density polyethylene (HDPE) permitting an IR imaging device to see through it. Embodiments of the apparatus 200 may include a privacy shutter having two doors, first door 222 and second door 224 which is described in more detail below. Thus, the apparatus 200 may have the first area 210 of the outer shell with an annular shape and the second area 220 located within a center area 215 defined by the annular shape of the first area 210.

In some embodiments, such as embodiments that are battery-powered, a motion sensor may be employed to detect large movements within the monitored space, or room. As one example of battery-energy conservation, in the absence of major motion, the apparatus may not capture full infrared images as often as it may when motion is detected. Thus, some embodiments may include a motion sensor 240, which may utilize a passive infrared detector, coupled to the processor, the passive infrared detector configured to detect motion within an area visible to the infrared sensor, wherein the passive infrared detector is separate from the infrared sensor located in the apparatus 200 and used to create low-resolution images of the room using infrared light. The motion detector may be a passive-infrared (PIR) sensor or some other type of motion sensor, such as a microwave based motion sensor. Motion Sensors utilizing infrared (IR) radiation (i.e. IR light) detectors are well known. Such sensors are often used in security systems or lighting systems to detect movement in a monitored space. An infrared detector detects changes in mid-infrared (IR) radiation having a wavelength of about 6-14 microns. These changes are due to temperature differences between a warm object, such as a warm blooded animal, and its background environment as the warm object moves through that environment.

A typical infrared detector utilizes a pyroelectric or piezoelectric substrate with a detector element that consists of conductive areas on opposite sides of the substrate, acting as a capacitor. As the substrate changes temperature, charge is added or subtracted to the capacitor, changing the voltage across the capacitor. The amount of mid-IR radiation that hits the detector element determines the temperature of that area of the substrate, and therefore, the voltage across the capacitor that makes up the detector element. Some motion sensors utilize an infrared detector that includes multiple detector elements. To reduce the chance of false alarms, some infrared detectors include a pair of equally sized detector elements of opposing polarities. Non-focused out-of-band radiation, as well as ambient temperature changes or physical shock, is equally incident on both detector elements, thus causing the signals from the equal and opposite elements to roughly cancel one another.

Many motion sensors incorporate an optical array (comprised of optical elements, such as lenses, focusing mirrors, and so on) to be able to monitor a large space with a single infrared detector. The optical array directs the IR radiation from multiple monitored volumes onto the infrared detector, which sometimes includes filters to minimize the radiation outside of the desired mid-infrared range from reaching the infrared detector. Each of the monitored volumes is typically a pyramidal shaped volume extending into the space to be monitored with the apex of the pyramid at the motion sensor. Concentrations of radiation from each of the pyramids are projected by the optical arrays on to the infrared detector where they are superimposed, and different regions of the infrared detector are heated based on the amount of IR radiation received from the superimposed images. The detector elements on the infrared detector react to the localized heating by changing their voltage. The resultant change in voltage across the detector elements is monitored and used to detect motion in the space being monitored.

In other embodiments, the second area of the shell is also transparent to the at least some wavelengths of infrared light and the passive infrared detector is positioned to receive infrared light through the second area with the movable cover for the second area of the outer shell also formed from a material that is transparent to the at least some wavelengths of infrared light and opaque to visible light.

The apparatus may also include a microwave transducer, coupled to the processor which is configured to detect motion of an object in the room in addition to, or in place of, the PIR-detector based motion sensor. In some embodiments, the microwave transducer is directional and mounted in a rotatable portion of the apparatus 200.

Embodiment of the apparatus 200 also include multiple-microphone array. The array may include three or more microphones coupled to the processor which is configured to adjust a directional sensitivity of the array. In the embodiment shown, there are 4 microphones in the array, including a first microphone 252 and a second microphone 254, which may be evenly distributed at cardinal points around the apparatus 200 and operated in concert with an internal DSP that provides beamforming, automatic echo-cancellation (AEC), automatic gain control (AGC), wake-word recognition, or other audio processing. In embodiments the DSP may be able to provide azimuth, pitch and distance clues to a sound, such as a speaker's voice. The system may also include a loudspeaker 256 and an audio amplifier.

FIG. 2C shows a detailed view of a portion of the embodiment of the room monitoring apparatus 200 of 2A/B. The apparatus 200 around the second area 220, which in this embodiment is simply an opening in the outer shell, is shown. In other embodiments, the second area 220 may be made from a material transparent to visible light, such as glass or clear plastic.

Embodiments of the apparatus 200 may include a privacy shutter (i.e. a movable cover) having two doors, first door 222 and second door 224. The movable cover may be under control of a processor in the apparatus 200. The movable cover 222, 224 for the second area 220 of the outer shell has a first position (shown in FIG. 2B) that blocks the visible light from the room from reaching the imaging sensor 261 and a second position (shown in FIG. 2C) that allows the visible light from the room to reach the imaging sensor 261. The movable cover can have many different embodiments including, but not limited to, a single piece that hinges or slides, two doors that hinge or slide, and an iris-type shutter which has multiple moving pieces. The cover, when in its closed position, reliably and intuitively covers the visible-light camera 261. It is advantageous to make it very obvious to area occupants when the cover is open. In the embodiment shown, the surface 225 that is exposed by the opening of the cover 222, 224 and is a part of the rotating portion of the apparatus 200, has a color that is highly contrasting with the area 215 around the opening 220. Thus in some embodiments of the apparatus 200, the rotatable portion 260 includes a surface 225 that is not visible from outside of the apparatus 200 while the movable cover 222, 224 is in the first (i.e. closed) position, but is visible from outside of the apparatus 200 while the movable cover 222, 224 is in the second (i.e. open) position, and the surface of the rotatable portion 225 has a contrasting color from a region 215 of the outer shell surrounding the second area 220.

In some embodiments, other indications are provided to warn an occupant that high-resolution images may be captured. The apparatus 200 includes two indicator lights 262A, 262B which can be illuminated at times the camera is active or even at all times that the cover 222, 224 is open. Different colors may be used for the lights to indicate different things to the user, such as using yellow to indicate that a picture may be taken at any time and red to indicate that video is currently being captured. In some embodiments, the act of opening or closing the cover is accompanied with a distinct sound effect, such as the sound of a servo operating. Note that in some embodiments, where the IR sensor is positioned to receive its IR radiation through the opening 220, the doors 222, 224 may be made from IR transparent material that is opaque to visible light.

The section of the rotatable portion behind the opening 220 may also include visible light sources 264 and/or NIR light sources 263, which can be used to illuminate the camera's 261 field of view as is appropriate for the lighting conditions and the comfort of the occupants. The visible light sources 264 and NIR light sources 263 may be light-emitting diodes (LED) and emit their radiation in the direction that the camera is facing. The LEDs can be turned on and off by software control. Thus the imaging sensor 261 may be able to capture both near-infrared and visible light and the apparatus 200 may include a near-infrared light source 263 and/or a a visible light source 264 under control of the processor and positioned to provide illumination for the imaging sensor 261 through the second area 220 of the outer shell.

FIG. 2D shows a stylized cross-sectional view of the embodiment of the room monitoring apparatus 200 of 2A/B. The apparatus 200 includes an outer shell 205, a static portion 270 fixed to a portion of the outer shell, and a rotatable portion 260 rotationally coupled to the static portion 270. In the embodiment shown, the rotatable portion 260 (which may be referred to as an imaging carriage) is configured to rotate within the outer shell 205. The apparatus 200 includes a motor 272 to rotate the rotatable portion 260 with respect to the static portion 270. Any type of motor 272 may be used, but in at least one embodiment, a flat low-torque brushless pancake design with electromagnet inductors formed with PCB windings, either on the base or on the carriage side, may be used and with the other part forming the stator with an array of fixed magnets. A conventional brushless three-phase waveform generator design, modified for low torque and high positional accuracy, with an active brake mode may also be used. A high-resolution position sensing system (Gray code or quadrature) may be included to provide information about the relative azimuth angle between the static portion 270 and the rotatable portion 260. Firmware running on a processor in the apparatus 200 may use the encoder's positioning data to control motor components to carry out rotation objectives such as swiveling to a specific angle and then stopping, or maintaining a given rotation speed and direction.

The apparatus may also include a bearing 278 to provide for low-friction rotation of the rotatable portion. In some embodiments, a hollow-core construction may be used to allow for optical communication through the center of the bearing 278. The hollow core of the bearing 278 can serve as a conduit for bi-directional optical infrared communication between electronics in the static portion 270 using optical transceiver 279 and the rotatable portion 260 using optical transceiver 269. Multi-megabit data rates may be provided to allow for transfer of compressed high resolution video from the camera 261. Other embodiments may utilize other communication mechanisms between the static portion 270 and the rotatable portion 260, including using wired communication links (with requisite limits on the rotation before the rotating portion 260 must be rotated in the opposite direction), wiping contacts that can transmit data as the rotating portion 260 moves, or contacts that mate at a single (or multiple) discrete rotational positions. While radio-frequency communication may also be used, care should be taken to adequate shield such communication to maintain privacy for the data being transmitted.

The rotating portion 260 may also include a battery 267 to provide power to the electronics of the rotating portion 260 as it moves. Because the rotating portion 260 rotates relative to the static portion, using a wired connection to provide power to the battery 267 would place constraints on the rotation. Embodiments may include a wireless charging transmitter 275 such as a charger compatible with the Qi™ standard in the static portion 270 and a compatible wireless charging receiver 265 on the rotating portion 260. This allows for charging of the battery 267 from a fixed power source for the apparatus 200. Energy can be opportunistically transferred between the static portion 270 and battery 267 on the rotating portion 260 as it rotates or the rotating portion may be parked in a position to maximize the transfer of power where the transmitter 275 and the receiver 265 are aligned.

The apparatus 200 includes a low-resolution, relatively inexpensive IR sensor 266 that includes a column of IR sensing elements (i.e. pixels) arranged in a line array or narrow vertically oriented grid, coupled to a lens to produce a 90+degree vertical spread of viewing angles for the detector pixels. The IR sensor 266 is positioned on the rotating portion 260 to receive IR radiation through the first area 210 of the outer shell 205, which is shaped as an annular ring. The IR sensor 266 sees only a narrow vertical slice of the full hemispherical view from the apparatus at any one time. As the rotatable portion 260 rotates, a different slice of the view is exposed to the IR sensor 266. An image-data buffer may be used to accumulate each slice until a desired portion of the hemispherical image is created. Updated data from the IR sensor is used to update vertical slices of the image-data buffer corresponding to the current azimuth angle.

In some embodiments, IR radiation 296 from a slice of the image corresponding to most or all of a range of elevation angles between 0° (horizontal from the apparatus mounted on the ceiling) and −90° (straight down) may be received by the IR sensor 266. While some embodiments may utilize optics that provide equal arcs of the elevation angle to the individual sensing elements of the IR sensor 266, other embodiments may include an optical subsystem arranged to direct the infrared light from a first elevational angle arc to a first infrared sensing element of the column of infrared sensing elements and to direct the infrared light from a second elevational angle arc, smaller than the first elevational angle arc, to a second infrared sensing element of the column of infrared sensing elements. In some embodiments, the IR sensing elements closer to the top (i.e. closer to the ceiling upon which the apparatus is mounted) have a smaller elevational angle arc than those farther down the column.

While the vertical resolution of an image created using information from the IR sensor 266 is limited to the number of IR sensing elements in a column of the IR sensor 266, the horizontal resolution of a resultant image is dependent upon the number of slices captured. The IR-image slice-integration rate may be limited by the accuracy of the control of the azimuth angle of the rotating portion and/or the speed at which the data can be scanned out of the IR sensor 266 and stitched with previously captured slices.. When the carriage is rotating slowly, the resulting image will have higher quality (horizontal resolution and SNR), but it will take longer to complete a revolution and generate a new complete hemispherical panorama image. Conversely, when the carriage is moving swiftly, the resulting image update rate will be higher but the image quality will be lower. Various embodiments may make different tradeoffs for speed and image quality for various purposes.

Similarly to how the elevational arc can be divided unevenly between pixels, the optical subsystem may be arranged to direct a first azimuth angle arc to the first infrared sensing element and to direct a second azimuth angle arc, smaller than the first azimuth angle arc, to the second infrared sensing element.

The imaging sensor 261, which may be a high-resolution camera capturing any wavelength or wavelengths of light to form an image, or a LIDAR unit that creates a depth map, is mounted on the rotatable portion 260 to obtain light through the second area 220 of the outer shell 205 which may have a movable cover 222 that can be used to block the imaging sensor 261 from view. The imaging sensor 261 may have a relatively wide field of view 291 that may cover most or all of the 90° elevational range below the apparatus and any range of azimuth directions such as 90° azimuthal range to provide square images, or wider azimuthal ranges to provide widescreen images.

The imaging sensor 261 in some embodiments may be offset by some distance, such as 40-50 mm in some embodiments, from a vertical axis about which the movable portion 260 rotates to create a parallax effect between two different positions of the imaging sensor 261. Two images taken from azimuthal positions 30 degrees apart will have a large overlap in the covered field of view—the amount based on the width of the field of view of the imaging sensor 261, but the position of the two positions will be spatially offset by >20 mm. This parallax distortion provides data basis for reconstruction of detailed 3-D scene geometry and enables the gauging of distance—thus adding some 3-D measurement capability to the apparatus. This effect may be of use during installation processes where the generated 3D visible-light image can be used for mapping of the covered room environment with a cloud-hosted AI scenery recognizer producing high-fidelity classification of scenery elements such as furniture (beds, chairs, tables, open floor space)—which is then stored and used as spatial context clues correlated with stick figure analysis—e.g. determining “normal” as opposed to unusual body postures for a given part of the room. Thus, the imaging sensor 261 positioned at a distance away from an axis of rotation of the rotatable portion to create a parallax effect for an object in the room captured in two different images by the imaging sensor at different azimuth angles of rotation of the rotatable portion.

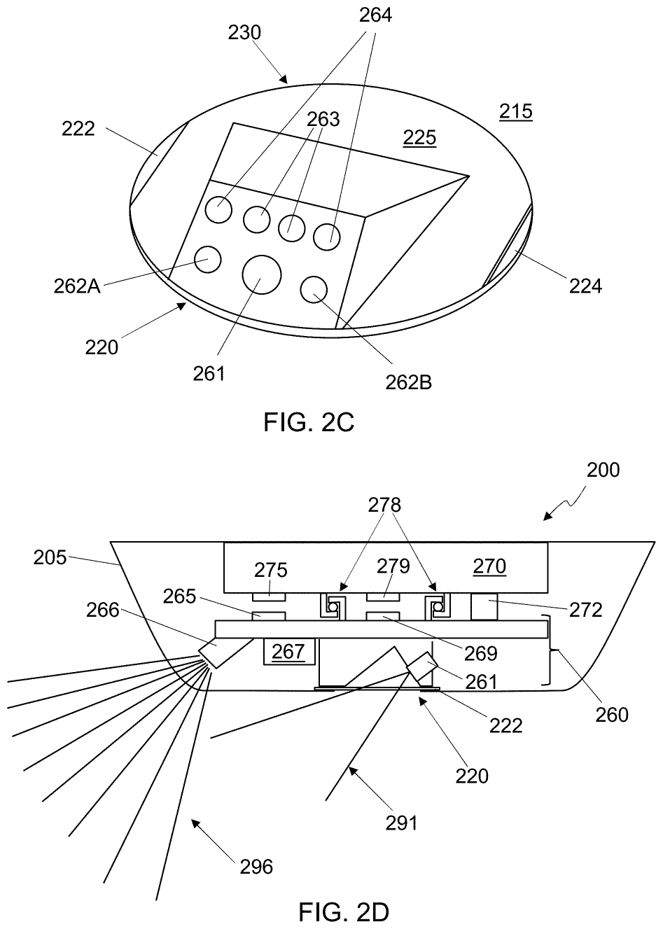

FIGS. 3A and 3B provide different views of an alternative embodiment of a room monitoring apparatus 300. FIGS. 3A and 3B show different aspects of the apparatus 300 and as such, a single view cannot show each and every element mentioned. The room monitoring apparatus 300 includes an outer shell that includes a first area 310 transparent to at least some wavelengths of infrared radiation, a second area 320 transparent to visible light, and a third area 330 adapted to be positioned on a surface of the room. The apparatus includes a static portion 304 fixed to a portion of the outer shell, such as the third area 330. The static portion may refer to inner structure or components that may be fixed to the outer shell.

The apparatus 300 also includes a rotatable portion 306, rotationally coupled to the static portion 304 and including an infrared sensor positioned to receive infrared light from the room through the first area 310 of the outer shell and an imaging sensor, separate from the infrared sensor, positioned to receive visible light from the room through the second area 320 of the outer shell. In some embodiments, the first area is transparent to mid-infrared light and the infrared sensor is sensitive to mid-infrared light. Thus, in some embodiments, the outer shell is divided into a first section 304 that includes the third area 330 and is fixed to the static portion, and a second section 306 that includes the first area 310 and the second area 320 and is fixed to the rotatable portion, wherein the second section 306 is rotationally coupled to the first section 304.

The room monitoring apparatus 300 also includes a motor arranged to rotate the rotatable portion 306 with respect to the static portion 304, a processor coupled to the infrared sensor and the imaging sensor, and a communications interface coupled to the processor. In some embodiments, the apparatus 300 further includes a smoke detector, a CO detector, or a glass-break detector, coupled to the processor. Many embodiments of the apparatus 300 include a microphone 352 and a speaker 356. Because the microphone 352 and the speaker 356 are included in the rotatable portion 306, the directionality of those components can be controlled by rotating the rotatable portion 306 with the motor under control of the processor.

In embodiments, the apparatus 300 can hide the lens of the imaging sensor (e.g. camera) using a two piece shutter (i.e. cover) that includes a first door 322 and a second door 324. The shutter can be opened to allow the imaging sensor to capture a high-resolution image or closed to provide the occupant a level of privacy.

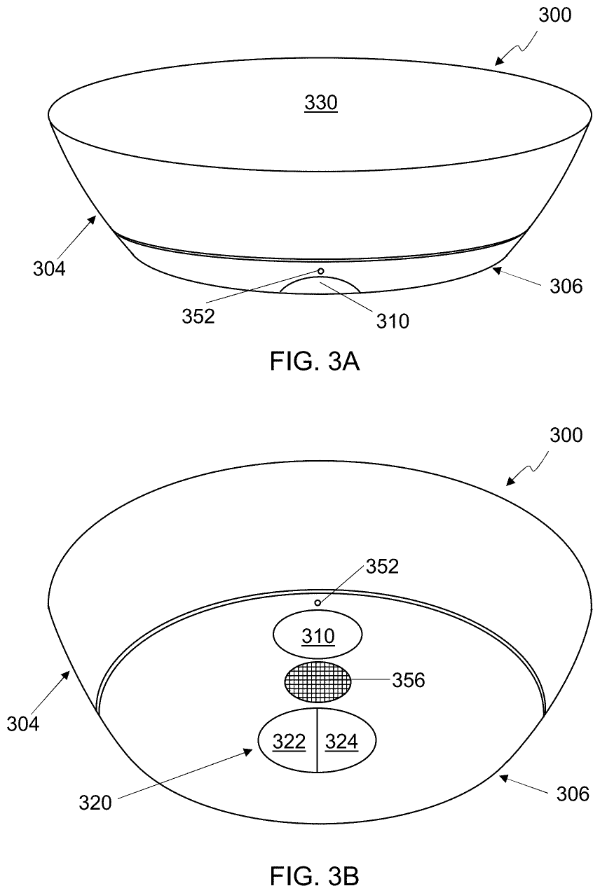

FIG. 4 shows an embodiment of a linear array of sensing elements 420 on a substrate 400 to form an infrared sensor 400. The linear array of sensing elements 420 of the embodiment shown includes 32 individual sensing elements 420 on the substrate 410 but other embodiments may have any number of sensing elements organized as a single column or as a 2D array. In embodiments, the column of infrared sensing elements consists of a number of sensing elements 420 that is small enough that an individual shown in a two-dimensional image formed using information from the sensor 400 cannot be identified. In some embodiments, the column of infrared sensing elements 420 consists of no more than 128 infrared sensing elements.

In the embodiment shown, the individual sensing elements are closely spaced together, with only enough space between the individual sensing elements to isolate them from each other. The sensing elements 420 are arranged in a linear array by spacing them along a single axis as shown. The infrared sensor 400 may be sensitive to various IR wavelengths, but in at least one embodiment, the IR sensor 400 is sensitive to mid-infrared (mid-IR) radiation having a wavelength of about 6-14 microns (μm). The individual sensing elements of the single linear array of the sensing elements 420 can use any technology, including, but not limited to, a pyroelectric detector, a piezoelectric detector, a bolometer, a thermocouple, a thermopile, a semiconductor charge-coupled device (CCD), or a complementary metal-oxide-semiconductor (CMOS) sensor.

In various embodiments, the lines coupled to the individual sensing elements of the array of sensing elements 420 may be individually routed to external electronic circuitry, or they may be combined and/or multiplexed by electronic circuitry included on the substrate 410 or packaged with the infrared sensor to reduce the number of I/O lines required. In at least one embodiment, the array may be addressable, allowing external electronic circuitry to provide an address of a particular individual sensing element so that internal electronic circuitry can provide a signal based on the characteristic of that individual sensing element which has been affected by infrared radiation. The details of the circuitry used to provide the signals from the array of sensing elements 420 depends on the embodiment of the infrared sensor 400, including the number of sensing elements and the technology of the sensing elements, as well as details of the packaging requirements.

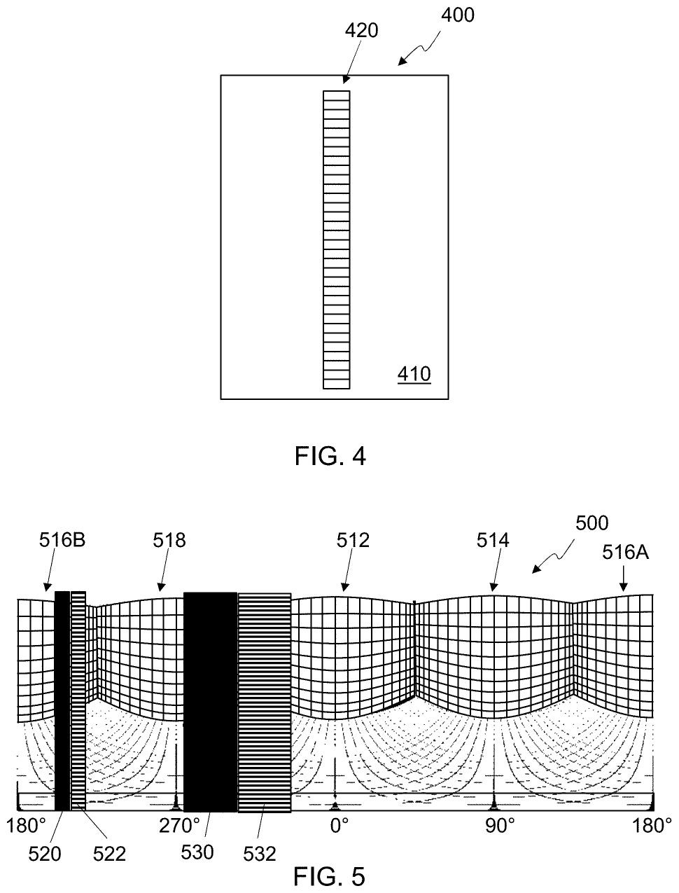

FIG. 5 shows how a panoramic image 500 of a room containing an embodiment of the room monitoring apparatus may be created. The image 500 shows a front wall 512, a right wall 514, a rear wall split into a first section 516A and a second section 516B if the image 500, and a left wall 518. While image processing algorithms may be used to unwarp the image after compositing, the image 500 shows data from the infrared sensor simply stitched together.

The information 520 crudely represents that information that may be received from an infrared sensor having a single column of sensing elements such as that shown in FIG. 4. Thus the image 500 may be formed using such a sensor in a device such as that shown in FIG. 2A-2D by receiving first information 520 from the infrared sensor with the rotatable portion in a first position and moving the rotatable portion of the apparatus to a second position. Second information 522 is then received from the infrared sensor with the rotatable portion in the second position and a two-dimensional image 500 is formed from the first information 520 and the second information 522. Once the image 500 has been formed, it may be analyzed to determine whether to send the two-dimensional image 500 to a remote computer and the image 500 may then be sent to the remote computer through the communications interface based on the determination.

In other embodiments, the infrared sensor may include one or more additional columns of infrared sensing elements to create a two dimensional array of infrared sensing elements. Such an embodiment may create a 2D array of information such as represented by information 530. In some embodiments, the first information 530 may be a large enough view of the room to allow the an image of the portion of the room to be formed based only on the first information 530. In such embodiments, an individual image (or succession of individual images) may be analyzed separately instead of or in addition to forming a panoramic image 500 for analysis. But in other embodiments, a method similar to that used with single column infrared sensor may be used to create the image 500 using an IR sensor with a 2D array, receiving first information 530 from the infrared sensor with the rotatable portion in a first position, moving the rotatable portion of the to a second position, receiving second information 532 from the infrared sensor with the rotatable portion in the second position and forming a two-dimensional image 500 with the first information 530 and the second information 532 both comprising a two dimensional array of infrared intensity levels. The first information 530 and second information 532 may be non-overlapping, such as immediately adjacent as shown in FIG. 5, but in some embodiments, the rotatable portion may be controlled so that the first information and the second information may overlap with each other. Overlapping information may be useful for generating an image with higher apparent resolution than could be generated using non-overlapping information and/or to use a parallax between the two sets of information to calculate a distance to an object in both sets of information, thus creating a depth map image that may be used in conjunction with (or a replacement of) the IR image.

The method of generating the 2D image 500 using the room monitoring apparatus with an infrared sensor on a rotatable portion can be generalized as configuring a processor to receive information from the infrared sensor, form a two-dimensional image utilizing the first information, serially move the rotatable portion to a plurality of additional positions, receive additional information from each of the plurality of additional positions, and use the additional information with the first information to form the two-dimensional image. The two dimensional image 500, which may be referred to as a panoramic image, may show any range of azimuth angles including ranges between 60 and 360 degrees, including a 90° degree wide image, a 180° wide image, and a 360° wide image.

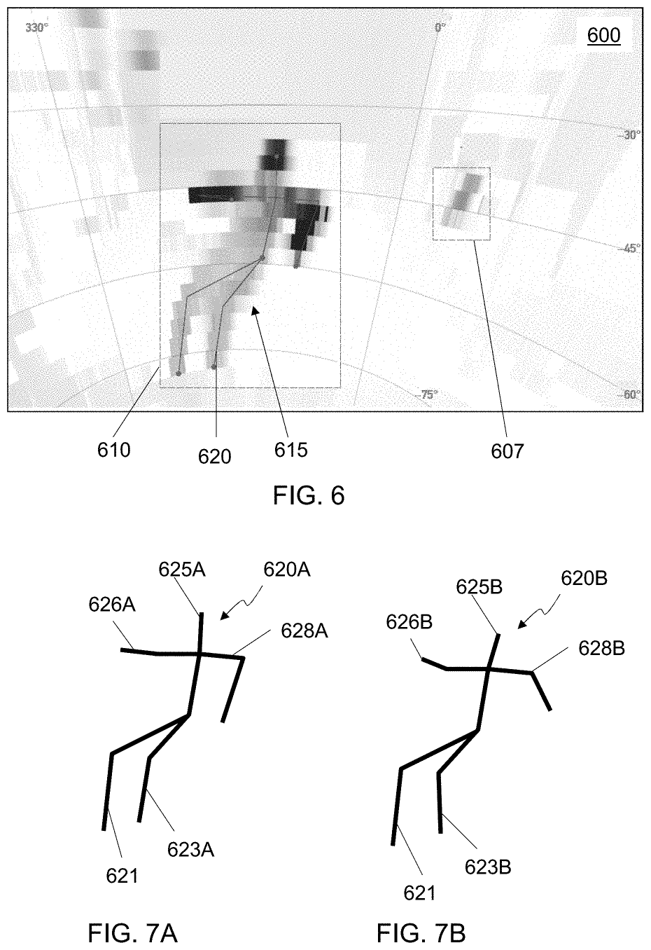

FIG. 6 shows an example low-resolution infrared image 600 created by the room monitoring apparatus. The image 600 includes a first region 610 that is determined to show a human form 615 and a second region 607 that may show a hazardous condition such as an overheated electrical appliance. In addition, a stick FIG. 620 may be created based on the human form 615. Any method can be used to determine the regions 610, 607 of interest and the human form 615, as well as to create a stick FIG. 620 from the human form 615, including guided machine learning, trained neural networks, pattern matching, or various other machine vision algorithms that are well known in the art.

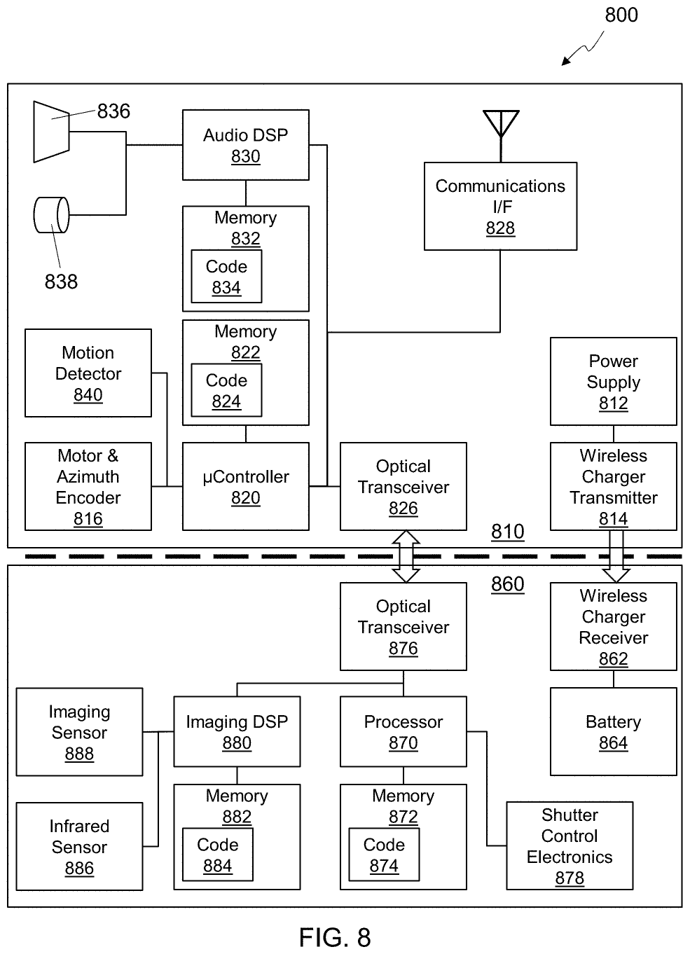

FIGS. 7A and 7B show examples of stick FIGS. 620A/B that may be extracted from low-resolution infrared images, such as image 600, by an embodiment of the room monitoring apparatus. Referring now to FIG. 7A, the stick FIG. 620A has several extremities identified, including a first leg 621, a second leg 623A, a first arm 626A, a second arm 628A, and a head 625A. The stick FIG. 620A may be determined to be in a prone position due to the relative position and perceived lengths of the extremities or other characteristics of the stick FIG. 620A. The stick FIG. 620A was extracted from the human form 615 shown in image 600 which was captured/formed at a first time. A second image may be captured/formed at a second time later than the first time. The elapsed time between the first time and second time may be of any duration, but may be dynamically selected based on previously detected movement in some embodiments. The elapsed time may typically be in the range of several seconds but may be much longer in some embodiments, up to several minutes or even an hour or longer.

The stick FIG. 620B was extracted from the second image and thus represents the human form at a later time than the stick FIG. 620A. Referring now to FIG. 7B, the stick FIG. 620B has the same extremities identified as were identified in FIG. 620A, including a first leg 621, a second leg 623B, a first arm 626B, a second arm 628B and a head 625B. Note that the first leg 621 did not move and the movements of the other extremities were small. This may be interpreted as a human in distress, especially if the human form 610 was found in a location of the room where it would be unusual for a person to lay prone for an extended period of time.

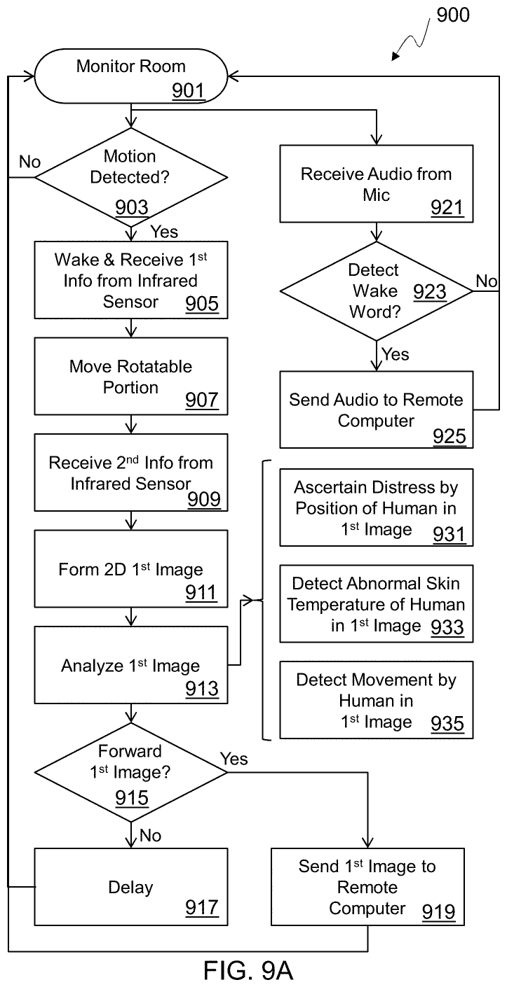

FIG. 8 is a block diagram of an embodiment of the room monitoring apparatus 800. The apparatus includes a static portion 810 and a rotatable portion 860 that are rotationally coupled. While one embodiment is described herein, other embodiments may partition the system differently and move various blocks between the static portion 810 and the rotatable portion 860. It should be noted that the apparatus 800 includes several elements that can process data, including the microcontroller 820, the audio DSP 830, the processor 870 and the imaging DSP 880 as well as potentially programmable elements of other components. All of these components together may be referred to as “a processor” and a mention of a processor in the claims may be interpreted to refer to any one of the elements in the apparatus 800 capable of being programmed, including those shown 820,830, 870, 880 and other elements that are not shown but are included in other embodiments, or any combination of those elements taken together. It should also be mentioned that a computing task described herein as being performed by a specific processor may be performed by a different processor (or even a different type of processor) in other embodiments. Similarly, the different memory blocks 822, 832, 872, 882 may be referred to as a computer-readable media, individually or in any combination. Each of the memory blocks 822, 832, 872, 882 may be any type of memory or combination of types of memory, including, but not limited to, dynamic random access memory (DRAM), double data-rate DRAM (DDR), read-only memory (ROM), NAND or NOR flash memory, a rotating-media hard drive, an optical storage media, or any other type of computer readable media capable of storing data that can be accessed by a processor.

A power supply 812 is coupled to the static portion 810 of the apparatus 800. The power supply may be AC power provided from the wiring of the room in which the device is deployed (hard-wired or plugged into an outlet), low-voltage AC or DC power provided through wiring to the device, a battery or other power source incorporated into the device, a wireless power receiver, or any other type of power source. The power supply 812 may be coupled to a wireless charger transmitter 814 in some embodiments which is configured to send power to a wireless charger receiver 862 in the rotatable portion 860 to charge a battery 864. The battery 864 can then supply power to the electronics of the rotatable portion 860. The wireless charger transmitter 814 and wireless charger receiver 862 may be configured to allow power to be transferred at one or more azimuth angles between the two portions in some embodiments. Thus, the rotatable portion 860 may include an energy storage device 864 and a wireless charging receiver 862 coupled to the energy storage device 864, and the static portion 810 may include a wireless charging transmitter 814 arranged to transmit power to the wireless charging receiver 862 in the rotatable portion 860.

The static portion 810 includes a microcontroller 820, which can be any type of processor, depending on the embodiment, coupled to a memory 822. The memory 822 may include code 824 which programs the microcontroller 820 (i.e. configures the microcontroller 820) to manage the apparatus 800 and communicate with a remote computer through the communications interface 828. The communications interface 828 may utilize a radio-frequency protocol such as WiFi, a wired protocol such as Ethernet, a power-line communications protocol such as HomePNA, or any other communications protocol over any physical medium.

The microcontroller 820 may control a motor 816 that may be used to rotate the rotatable portion 860 with respect to the static portion 810, that is, the processor 820 may be configured to control the motor 816 to position the rotatable portion 860 at a selected rotational position with respect to the static portion 810. An azimuth encoder may also be included to allow the microcontroller 820 to accurately determine a rotational position of the rotatable portion 860 with respect to the static portion 810.

Some embodiments may include a motion detector 840, which may include a passive-IR detector, coupled to the microcontroller 820. The motion detector 840 may be used to wake the microcontroller 840 from a low-power state when motion is detected in the room.

An audio digital signal processor (DSP) 830 may be included in some embodiments. The audio DSP 830 may be coupled to one or more microphones 838 and a speaker subsystem 836 which may include an audio amplifier. The one or more microphones 838 may be configured as an array microphone allowing the DSP 830 to control the directionality of the microphones 838. The audio DSP 830 may also be coupled to memory 832 which contains code 834 to program the audio DSP 830 to perform various audio signal processing such as controlling the directionality of the microphones 838, performing echo cancellation, performing automatic gain control, or performing speech recognition such as recognizing a wake-word.

The microcontroller 820 may also be coupled to a first optical transceiver 826 to communicate with a second optical transceiver 876 located on the rotatable portion 860. So the static portion 810 may include a first optical data transceiver 826 and the communications interface 828 while the rotatable portion 860 may include a second optical data transceiver 876 arranged to communicate with the first optical transceiver 826. The optical transceivers 826, 876 may utilize infrared light for communication. Although other embodiments may utilize wired or radio-frequency (RF) communication to transmit data between the fixed portion 810 and the rotatable portion 860, an advantage of using optical communication between the two portions 810, 860 is that it may allow for unlimited rotation of the rotatable portion 860. In addition, ensuring that the communication cannot be intercepted outside of the apparatus 800 to keep the communication totally private may be easier to do with optical communication than with RF communication. The optical communication may be accomplished in some embodiments by using an annular bearing to couple the static portion 810 to the rotatable portion 860 and positioning the first optical data transceiver 826 and the second optical data transceiver 876 to communicate through a center of the annular bearing.

Another processor 870 may be included in the rotatable portion, coupled to the optical transceiver 876 and memory 872 containing code 874 to program the processor 870. The processor 870 may also be coupled to shutter control electronics 878 to allow the processor 870 to open and close a movable cover for the imaging sensor 888.

Embodiments may also include an imaging DSP 880, coupled to memory 882 storing code 884 for the imaging DSP 880. The imaging DSP 880 may be coupled to an infrared sensor 886 and an imaging sensor 888. The imaging sensor 888 may have a higher spatial resolution than the infrared sensor 886. The imaging DSP 880 may be a part of a conventional camera chipset specifically designed to process an image stream from a camera to generate output video streams and or still images, or a more general purpose DSP programmed for such tasks by the code 884. The imaging DPS 880 may also perform AGC and white balance compensation, and also may send gain and focus commands to the imaging sensor 888 in some embodiments. The imaging DSP 880 may also be able to perform simple overlay compositing to, for example, superimpose a semitransparent image created from the IR sensor 886 over the active view from the imaging sensor 888, which may be a visible-light camera in some embodiments.

In some embodiments, imaging sensor 888 may be a LIDAR unit. In other embodiments, the imaging sensor 888 may be a compact color camera module similar to types used in cellular telephones, except with no infrared filter. The rotating portion 860 may also include NIR and/or visible light illumination LEDs positioned to provide illumination to the field of view of the imaging sensor.

In some embodiments, the infrared sensor 886 includes a column of infrared sensing elements arranged to receive the infrared light from a single azimuth direction at each infrared sensing element of the column of infrared sensing elements and arranged to receive the infrared light from different elevation angles at different infrared sensing elements of the column of infrared sensing elements, the single azimuth direction determined by a relative rotation between the rotatable portion 860 and the static portion 810. A single azimuth direction should be interpreted as a narrow range of azimuth angles based on the size of the individual infrared sensing elements and associated optics, with each infrared sensing element receiving IR radiation from a small range of azimuth angles that includes the single azimuth direction.

The imaging DSP 880 may be programmed to receive successive hemispherical IR image slices from the infrared sensor 886 and stitch (i.e. composite) them together into an IR image based on a polar coordinate grid with azimuth along the horizontal axis and elevation along the vertical axis. The imaging DSP 880 may be able to generate corrected-geometry 2D views for select viewing angles from the IR image in polar coordinates. The imaging DSP 880 may additionally store multiple IR images in the memory 872 to allow for temporal situation analysis.

The IR image is a monochrome matrix of IR emission intensity samples. As done in conventional thermal cameras, such as those known as forward-looking infrared (FLIR) cameras, it is possible to correlate these different intensities with specific surface temperatures of background, objects and people within the monitored area. Ambient-air temperature readings may be of use in achieving calibration of the observed values. The stored IR-image values may be normalized such that for the reasonable temperature range of the observed scene the values are represented economically with around 8 bits of usable, representative resolution in some embodiments.

The imaging DSP 880 and/or processor 870 may also perform the analysis of the IR image to determine whether it shows a person that may be in distress. It should be noted that a person may be determined to be in distress whether or not they are actually aware of the situation. For example an individual may be perfectly content even though a fire is about to break out due to an overheated electrical appliance, which is interpreted as the individual being in distress for the purposes of this disclosure, including the claims. The processors 880, 870 may use any method to determine that an image or images show a person in distress, including various AI or machine-learning techniques and/or any form of image processing. In some embodiments, the Audio DSP 830 may analyze audio captured by the microphones 838 to provide additional information which may be used to determine that an individual may be in distress.

Aspects of various embodiments are described with reference to flowchart illustrations and/or block diagrams of methods, apparatus, systems, and computer program products according to various embodiments disclosed herein. It will be understood that various blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The flowchart and/or block diagrams in the figures help to illustrate the architecture, functionality, and operation of possible implementations of systems, methods and computer program products of various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special-purpose hardware and computer instructions.

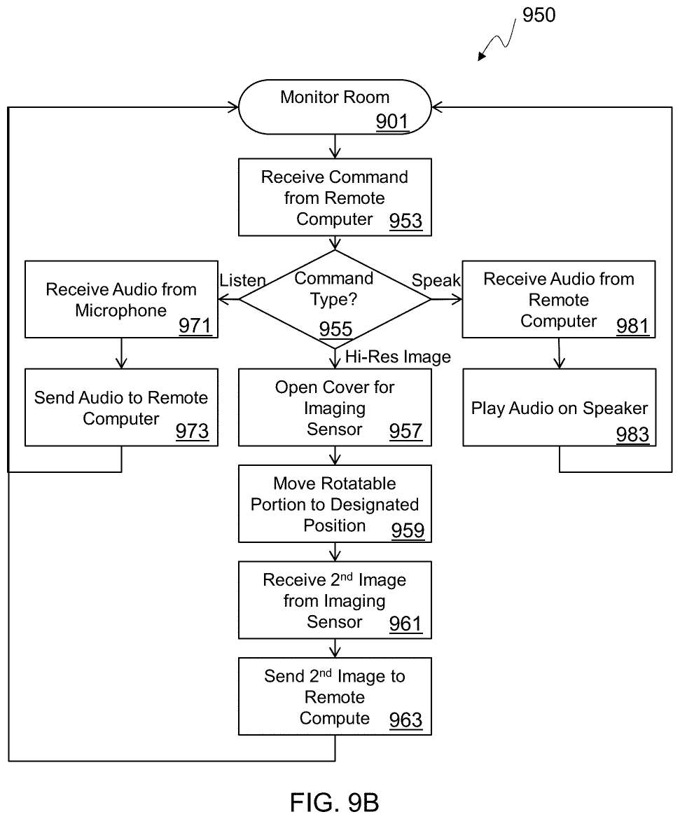

FIG. 9A and 9B show flowcharts 900, 950 of embodiments of a method for use by a room monitoring device such as a Skypod device as described herein. The room monitoring device includes a rotatable portion with an imaging sensor, and an infrared sensor that includes a column of infrared sensing elements arranged to receive light from a single azimuth direction determined by a relative rotation between the rotatable portion and the static portion. The room monitoring device may monitor 901 a room using the included sensors.

The room monitoring device may continue to monitor 901 the room until (optionally) receiving 903 a wake event from a motion detector of the room monitoring device while in a low-power state. The wake event may indicate that motion was detected in the room. The room monitoring device may exit the low-power state in response to the receiving of the wake event before proceeding with receiving 905 first information from the infrared sensor with the rotatable portion in a first position. Some embodiments may not include a motion detector and the room monitoring device may continuously or periodically initiate receiving information from the infrared sensor.

In some embodiments, the method continues with moving 907 the rotatable portion of the room monitoring device to a second position and receiving 909 second information from the infrared sensor with the rotatable portion in the second position. A two-dimensional (2D) first image is then formed 911 utilizing the first information and may utilize both the first information and the second information if the second information is available. Any number of additional sets of information may be collected from the infrared sensor with the rotatable portion at various azimuth angles which can then be used to form the 2D image. In some embodiments, the infrared sensor has no additional columns of infrared sensing elements (i.e. it has only a single column of elements), so the first information and the second information both individually include infrared intensity information from only the column of infrared sensing elements. In other embodiments, the infrared sensing element includes one or more additional columns of infrared sensing elements (i.e. it has a 2D array of elements) so that the first information (and the second information if received) includes infrared intensity information from a two dimensional array of infrared sensing elements.

The method includes analyzing 913 the first image within the room monitoring device, that is, using computing resources included in the room monitoring device without sending the first image to another device outside of the room monitoring device. The analyzing may include determining whether a person shown in the image may be in distress or otherwise have a threat to their health or safety. This may include ascertaining that the first image shows a hazardous environmental condition, such as an overheated electrical device or the presence of unexpected individuals in the room. In some embodiments, such a determination may include analyzing the first image to ascertain 931 that the first image shows a person in a position that indicates the person may be in distress or that the person has an abnormal skin temperature 933.

In embodiments, the analyzing of the first image may include discovering a region of the first image that shows a human form, calculating positions of one or more extremities of the human form, and ascertaining that the positions of the one or more extremities indicate that a person represented by the human form may be in distress. In some embodiments, the analyzing of the first image may include discovering a region of the first image that shows a human form, determining a skin temperature of the human form, and ascertaining that the skin temperature indicates that a person represented by the human form may be in distress.

In some embodiments, the analyzing may include detection 935 of movement by a person in the image that indicates that the person may be in distress. This movement may be a type of movement, an amount of movement (including a lack of movement), or a combination of the two, and may be combined with the positions of the extremities of the human form in the determination of possible distress. This may include forming a third image based on information captured by the infrared sensor at an earlier time than a time that the first information was captured by the infrared sensor, and including both the third image and the first image in the analyzing. This may also include discovering a human form shown in both the first image and the third image, determining an amount of movement of the human form between the third image and the first image, and ascertaining that the amount of movement indicates that a person represented by the human form may be in distress.

The ascertaining and determining described above may be used to determine 915 whether to forward the first image to a remote computer based on the analyzing of the first image. If a determination is made not to forward the first image due to a lack of evidence of distress of a human or a threat to health and safety of the occupant, the room monitoring device may simply delay 917 for some period of time before beginning the method once again. If a determination of distress of a human or a threat to health and safety of the occupant was found, the method may then send 919 the first image to the remote computer based on the determination. In some embodiments the room monitoring device may await further commands as shown in flowchart 950, but in other embodiments, it may simply restart the method of flowchart 900.

In some embodiments, the room monitoring device may perform a method that includes receiving 921 audio from a microphone and recognizing 923 a wake word in the audio. The wake word may be predetermined at the time of manufacture of the device or may be a user-programmable setting for the device, depending on the embodiment. The wake word is recognized using computing resources within the room monitoring device so that the audio analyzed for the wake word does not need to be sent outside of the device. Once the wake word has been recognized, at least a portion of the received audio is sent 925 to the remote computer in response to the recognition of the wake word. The remote computer may then perform speech recognition on the audio to determine what actions to take.

The room monitoring device may also, as shown in flowchart 950 of FIG. 9B, receive 953 a command from a remote computer and determine 955 what type of command was sent. If a command is received indicating that the device should listen to what is going on in the room, the method continues with receiving 971 a second audio segment from a microphone in the device and sending 973 the second audio segment to the remote computer. If a command is received indicating that the device should play some audio in the room (e.g. speak), the method continues with receiving 981 a first audio segment from the remote computer and playing 983 the first audio segment through a speaker in the device.

If a command is received indicating that the device should capture a high-resolution image, the method continues by opening 957 a cover to allow visible light to be received by the imaging sensor. In some embodiments, an indication that the second image is being captured by the imaging sensor may be provided, such as a lighted indicator, a high contrast color exposed by the opening of the cover, an audible sound, or any combination thereof. The rotatable portion is then moved 959 to a designated position based on the command and a second image is received 961 from the imaging sensor. The second image has a higher spatial resolution than the first image. In some embodiments, the opening of the cover also allows near-infrared light to be received by the imaging sensor, and the second image is based at least in part, on near infrared light intensities. The second image is then sent 963 to the remote computer and the room monitoring device waits for another command to be received.

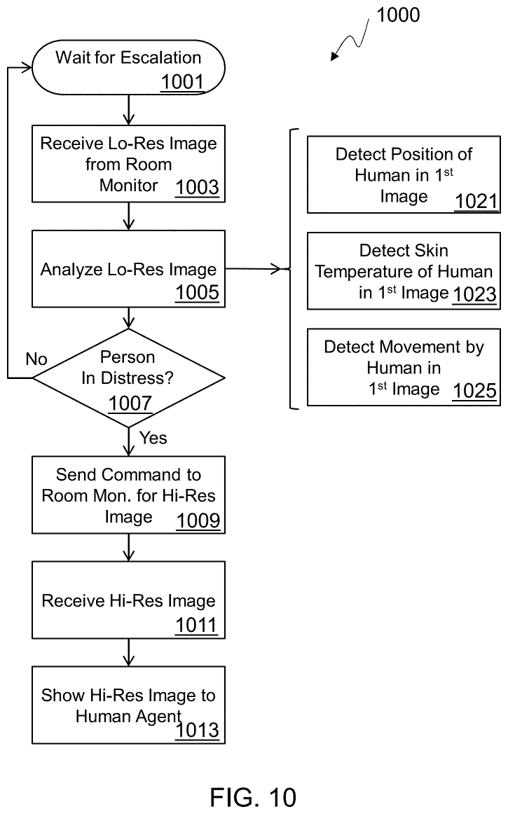

FIG. 10 shows a flowchart 1000 of an embodiment of a method for use by a remote computer in communication with a room monitoring apparatus. The method waits 1001 for escalation by the apparatus which is indicated by the reception 1003 of a low-resolution image from the apparatus. Low-resolution, as the term is used herein may mean that the image does not have enough spatial resolution to allow an individual in the image to be recognized and it may mean that the horizontal resolution is 128 lines or fewer, or in other embodiments 64 lines or less, such as 32 lines. The low-resolution image is analyzed 1005 using the compute resources of the remote computer(s), which may be cloud-computing resources in some embodiments. In some embodiments, the analyzing may include detection of an unnatural position 1021 of a human in the first image, detection of an abnormal skin temperature 1023 of a human in the first image, or detection of movement 1025 (or lack thereof) by a human in the first image. If the analyzing determines that the individual in the first image may be in distress 1007, a command may be sent 1009 to the apparatus to capture a high-resolution image for further analysis. In other embodiments, audio communication with the room (listening or bi-directional) may be requested instead of or in addition to the high-resolution image. The high resolution image is then received 1011 and may then be shown 1013 to a human agent for determination of what should be done next.

As will be appreciated by those of ordinary skill in the art, aspects of the various embodiments may be embodied as a system, device, method, or computer program product apparatus. Accordingly, elements of the present disclosure may take the form of an entirely hardware embodiment, an entirely software embodiment (including firmware, resident software, micro-code, or the like) or an embodiment combining software and hardware aspects that may all generally be referred to herein as a “server,” “circuit,” “module,” “client,” “computer,” “logic,” or “system,” or other terms. Furthermore, aspects of the various embodiments may take the form of a computer program product embodied in one or more computer-readable medium(s) having computer program code stored thereon.

Any combination of one or more computer-readable storage medium(s) may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store a program and/or data for use by or in connection with an instruction execution system, apparatus, or device. Even if the data in the computer-readable storage medium requires action to maintain the storage of data, such as in a traditional semiconductor-based dynamic random access memory, the data storage in a computer-readable storage medium can be considered to be non-transitory. A computer data transmission medium, such as a transmission line, a coaxial cable, a radio-frequency carrier, and the like, may also be able to store data, although any data storage in a data transmission medium can be said to be transitory storage. Nonetheless, a computer-readable storage medium, as the term is used herein, does not include a computer data transmission medium.

Computer program code for carrying out operations for aspects of various embodiments may be written in any combination of one or more programming languages, including object oriented programming languages such as Java, Python, C++, or the like, conventional procedural programming languages, such as the “C” programming language or similar programming languages, or low-level computer languages, such as assembly language or microcode. The computer program code if loaded onto a computer, or other programmable apparatus, produces a computer implemented method. The instructions which execute on the computer or other programmable apparatus may provide the mechanism for implementing some or all of the functions/acts specified in the flowchart and/or block diagram block or blocks. In accordance with various implementations, the program code may execute entirely on the user's computer, partly on the user's computer, as a stand-alone software package, partly on the user's computer and partly on a remote computer or entirely on the remote computer or server, such as a cloud-based server. In the latter scenario, the remote computer may be connected to the user's computer through any type of network, including a local area network (LAN) or a wide area network (WAN), or the connection may be made to an external computer (for example, through the Internet using an Internet Service Provider). The computer program code stored in/on (i.e. embodied therewith) the non-transitory computer-readable medium produces an article of manufacture.

The computer program code, if executed by a processor causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So a processor programmed to perform a task is transformed from what the processor was before being programmed to perform that task, much like a physical plumbing system with different valves can be controlled to change the physical flow of a fluid.

Examples of various embodiments are described in the following paragraphs:

Embodiment 1. A room monitoring apparatus comprising: an outer shell that includes a first area transparent to at least some wavelengths of infrared radiation, a second area transparent to visible light, and a third area adapted to be positioned on a surface of the room; a static portion fixed to a portion of the outer shell; a rotatable portion, rotationally coupled to the static portion and including an infrared sensor positioned to receive infrared light from the room through the first area of the outer shell and an imaging sensor, separate from the infrared sensor, positioned to receive visible light from the room through the second area of the outer shell; a motor arranged to rotate the rotatable portion with respect to the static portion; a processor coupled to the infrared sensor and the imaging sensor; and a communications interface coupled to the processor.

Embodiment 2. The apparatus of embodiment 1, the imaging sensor having a higher spatial resolution than the infrared sensor.

Embodiment 3. The apparatus of embodiment 1 or 2, the imaging sensor positioned at a distance away from an axis of rotation of the rotatable portion to create a parallax effect for an object in the room captured in two different images by the imaging sensor at different azimuth angles of rotation of the rotatable portion.

Embodiment 4. The apparatus of any of embodiments 1 through 3, wherein the first area is transparent to mid-infrared light and the infrared sensor is sensitive to mid-infrared light.

Embodiment 5. The apparatus of any of embodiments 1 through 4, further comprising a movable cover for the second area of the outer shell having a first position that blocks the visible light from the room from reaching the imaging sensor and a second position that allows the visible light from the room to reach the imaging sensor.

Embodiment 6. The apparatus of embodiment 5, the rotatable portion comprising a surface that is not visible from outside of the apparatus while the movable cover is in the first position, but is visible from outside of the apparatus while the movable cover is in the second position; the surface of the rotatable portion having a contrasting color from a region of the outer shell surrounding the second area.

Embodiment 7. The apparatus of embodiment 5 or 6, the movable cover under control of the processor.

Embodiment 8. The apparatus of embodiments 5 through 7, wherein the movable cover and second area are transparent to the at least some wavelengths of infrared light; and the first area and the second area overlap each other so that the infrared sensor can receive the infrared light from the room with the movable cover in the first position.

Embodiment 9. The apparatus of any of embodiments 1 through 8, the second area comprising an opening in the outer shell.

Embodiment 10. The apparatus of any of embodiments 1 through 9, further comprising a visible light source under control of the processor and positioned to provide illumination for the imaging sensor.

Embodiment 11. The apparatus of embodiment 10, the rotatable portion comprising the visible light source positioned to provide visible light through the second area.

Embodiment 12. The apparatus of any of embodiments 1 through 11, further comprising a light source suitable to provide illumination for the room and controllable by a user.

Embodiment 13. The apparatus of any of embodiments 1 through 12, further comprising a near-infrared light source; wherein the imaging sensor captures both near-infrared and visible light.

Embodiment 14. The apparatus of embodiment 13, wherein the near-infrared light source is positioned to provide near-infrared light to the room through the second area of the outer shell.

Embodiment 15. The apparatus of any of embodiments 1 through 14, the outer shell divided into a first section that that includes the third area and is fixed to the static portion, and a second section that includes the first area and the second area and is fixed to the rotatable portion, wherein the second section is rotationally coupled to the first section.

Embodiment 16. The apparatus of any of embodiments 1 through 14, wherein the rotatable portion is configured to rotate within the outer shell.

Embodiment 17. The apparatus of any of embodiments 1 through 16, the first area of the outer shell having an annular shape and the second area located within a center area defined by the annular shape of the first area.

Embodiment 18. The apparatus of any of embodiments 1 through 16, further comprising a microphone and a speaker.

Embodiment 19. The apparatus of embodiment 18, the microphone comprising an array of three or more microphones coupled to the processor which is configured to adjust a directional sensitivity of the array.

Embodiment 20. The apparatus of any of embodiments 1 through 19, the rotatable portion further comprising an energy storage device and a wireless charging receiver coupled to the energy storage device; and the static portion comprising a wireless charging transmitter arranged to transmit power to the wireless charging receiver in the rotatable portion.

Embodiment 21. The apparatus of any of embodiments 1 through 20, the processor configured to determine a rotational position of the rotatable portion with respect to the static portion.

Embodiment 22. The apparatus of any of embodiments 1 through 21, the motor under control of the processor.

Embodiment 23. The apparatus of embodiment 22, the processor configured to control the motor to position the rotatable portion at a selected rotational position with respect to the static portion.

Embodiment 24. The apparatus of any of embodiments 1 through 23, the static portion comprising a first optical data transceiver and the communications interface; and the rotatable portion further comprising a second optical data transceiver arranged to communicate with the first optical transceiver.

Embodiment 25. The apparatus of embodiment 24, further comprising an annular bearing coupling the static portion to the rotatable portion, the first optical data transceiver and the second optical data transceiver positioned to communicate through a center of the annular bearing.

Embodiment 26. The apparatus of embodiment 24 or 25, the first optical data transceiver and the second optical data transceiver utilizing infrared light for communication.

Embodiment 27. The apparatus of any of embodiments 1 through 26, further comprising a passive infrared detector coupled to the processor, the passive infrared detector configured to detect motion within an area visible to the infrared sensor, wherein the passive infrared detector is separate from the infrared sensor.

Embodiment 28. The apparatus of embodiment 27, wherein the second area is also transparent to the at least some wavelengths of infrared light and the passive infrared detector is positioned to receive infrared light through the second area; the apparatus further comprising a movable cover for the second area of the outer shell that is transparent to the at least some wavelengths of infrared light and opaque to visible light.

Embodiment 29. The apparatus of any of embodiments 1 through 28, the infrared sensor comprising a column of infrared sensing elements arranged to receive the infrared light from a single azimuth direction at each infrared sensing element of the column of infrared sensing elements and arranged to receive the infrared light from different elevation angles at different infrared sensing elements of the column of infrared sensing elements, the single azimuth direction determined by a relative rotation between the rotatable portion and the static portion.

Embodiment 30. The apparatus of embodiment 29, wherein the column of infrared sensing elements consists of no more than 128 infrared sensing elements.

Embodiment 31. The apparatus of embodiment 29 or 30, further comprising an optical subsystem, the optical subsystem arranged to direct the infrared light from a first elevational angle arc to a first infrared sensing element of the column of infrared sensing elements and to direct the infrared light from a second elevational angle arc, smaller than the first elevational angle arc, to a second infrared sensing element of the column of infrared sensing elements.

Embodiment 32. The apparatus of embodiment 31, the optical subsystem arranged to direct a first azimuth angle arc to the first infrared sensing element and to direct a second azimuth angle arc, smaller than the first azimuth angle arc, to the second infrared sensing element.

Embodiment 33. The apparatus of any of embodiments 29 through 32, the processor configured to: receive first information from the infrared sensor with the rotatable portion in a first position; move the rotatable portion to a second position; receive second information from the infrared sensor with the rotatable portion in the second position; and form a two-dimensional image from the first information and the second information; analyze the two-dimensional image to determine whether to send the two-dimensional image to a remote computer; and send the two dimensional image to the remote computer through the communications interface based on the determination.

Embodiment 34. The apparatus of embodiment 33, the infrared sensor comprising one or more additional columns of infrared sensing elements to create a two dimensional array of infrared sensing elements; and the first information and the second information both comprising a two dimensional array of infrared intensity levels.

Embodiment 35. The apparatus of any of embodiments 29 through 34, the infrared sensor comprising one or more additional columns of infrared sensing elements to create a two dimensional array of infrared sensing elements; the processor configured to: receive information representing a two-dimensional image from the infrared sensor; analyze the two-dimensional image to determine whether to send the two-dimensional image to a remote computer; and send the two dimensional image to the remote computer through the communications interface based on the determination.

Embodiment 36. The apparatus of any of embodiments 29 through 35, the processor configured to: receive information from the infrared sensor; and form a two-dimensional image utilizing the first information.

Embodiment 37. The apparatus of embodiment 36, the processor further configured to:

serially move the rotatable portion to a plurality of additional positions; receive additional information from each of the plurality of additional positions; and use the additional information with the first information to form the two-dimensional image; wherein the two dimensional image shows a range of azimuth angles of between 60 and 360 degrees.

Embodiment 38. The apparatus of embodiment 36 or 37, wherein the column of infrared sensing elements consists of a number of sensing elements that is small enough that an individual shown in the two-dimensional image cannot be identified.

Embodiment 39. The apparatus of any of embodiments 36 through 38, the processor further configured to: analyze the two-dimensional image to determine whether to send the two-dimensional image to a remote computer through the communications interface; and send the two-dimensional image to the remote computer through the communications interface based on the determination.

Embodiment 40. The apparatus of any of embodiments 1 through 39, the communications interface configured to utilize radio frequency communication to communicate with an entity outside of the apparatus.

Embodiment 41. The apparatus of any of embodiments 1 through 40, the processor configured to communicate with a cloud-based resource through the communications interface.

Embodiment 42. The apparatus of any of embodiments 1 through 41, the processor configured to: receive a command through the communications interface; move the rotatable portion to a designated position based on the command; receive an image from the imaging sensor; and send the image to a remote computer through the communications interface.

Embodiment 43. The apparatus of any of embodiments 1 through 42, further comprising a smoke detector, a CO detector, or a glass-break detector, coupled to the processor.

Embodiment 44. The apparatus of any of embodiments 1 through 43, further comprising a microwave transducer, coupled to the processor which is configured to detect motion of an object in the room.

Embodiment 45. The apparatus of embodiment 44, the microwave transducer being directional and mounted in the rotatable portion.

Embodiment 46. The apparatus of any of embodiments 1 through 45, the processor configured to: receive information from the infrared sensor; and form a two-dimensional image utilizing the information; and send the two-dimensional image to a remote computer through the communications interface.

Embodiment 47. A room monitoring system comprising: the apparatus of embodiment 46; and at least one machine readable medium comprising one or more instructions that in response to being executed on the remote computer cause the remote computer to carry out a method comprising: receiving the two-dimensional image from the apparatus; analyzing of the image to ascertain whether the first image shows a person in a position that indicates the person may be in distress; determining whether to escalate to a human agent based on the analyzing; sending a command to the apparatus to capture an image of the person based on the determination; and receiving that image of the person.

Embodiment 48. A method for use in a room monitoring device including a rotatable portion with an imaging sensor, and an infrared sensor that includes a column of infrared sensing elements arranged to receive light from a single azimuth direction determined by a relative rotation between the rotatable portion and the static portion, the method comprising: receiving first information from the infrared sensor with the rotatable portion in a first position; forming a two-dimensional first image utilizing the first information; analyzing the first image within the room monitoring device; determining whether to forward the first image to a remote computer based on the analyzing of the first image; sending the first image to the remote computer based on the determination; receiving a command from remote computer; moving the rotatable portion to a designated position based on the command; receiving a second image from the imaging sensor, the second image having a higher spatial resolution than the first image; and sending the second image to the remote computer.

Embodiment 49. The method of embodiment 48, further comprising: moving the rotatable portion of the room monitoring device to a second position; receiving second information from the infrared sensor with the rotatable portion in the second position; and forming the first image utilizing both the first information and the second information.

Embodiment 50. The method of embodiment 48 or 49, wherein the first information and the second information both individually include infrared intensity information from only the column of infrared sensing elements, wherein the infrared sensor has no additional columns of infrared sensing elements.

Embodiment 51. The method of embodiment 48 or 49, wherein the first information includes infrared intensity information from a two dimensional array of infrared sensing elements.

Embodiment 52. The method of any of embodiments 48 through 51, further comprising:

receiving a wake event from a motion detector of the room monitoring device while in a low-power state; exiting the low-power state in response to the receiving of the wake event before proceeding with the receiving of the first information.

Embodiment 53. The method of any of embodiments 48 through 51, further comprising:

opening a cover to allow visible light to be received by the imaging sensor before the receiving of the second image from the imaging sensor; and providing an indication that the second image is being captured by the imaging sensor; wherein the indication comprises a lighted indicator, a high contrast color exposed by the opening of the cover, an audible sound, or any combination thereof

Embodiment 54. The method of any of embodiments 48 through 51, further comprising:

receiving audio from a microphone; recognizing a wake word in the audio; and sending at least a portion of the received audio to the remote computer in response to the recognition of the wake word.

Embodiment 55. The method of any of embodiments 48 through 54, further comprising:

receiving a first audio segment from the remote computer; playing the first audio segment through a speaker; receiving a second audio segment from a microphone; and sending the second audio segment to the remote computer.

Embodiment 56. The method of any of embodiments 48 through 55, wherein the opening of the cover also allows near-infrared light to be received by the imaging sensor, and the second image is based at least in part, on near infrared light intensities.

Embodiment 57. The method of any of embodiments 48 through 56, the analyzing of the first image comprising ascertaining that the first image shows a person in a position that indicates the person may be in distress.

Embodiment 58. The method of any of embodiments 48 through 57, the analyzing of the first image comprising ascertaining that the first image shows a hazardous environmental condition.

Embodiment 59. The method of any of embodiments 48 through 58, the analyzing of the first image comprising: discovering a region of the first image that shows a human form; calculating positions of one or more extremities of the human form; and ascertaining that the positions of the one or more extremities indicate that a person represented by the human form may be in distress.

Embodiment 60. The method of any of embodiments 48 through 59, the analyzing of the first image comprising: discovering a region of the first image that shows a human form; determining a skin temperature of the human form; and ascertaining that the skin temperature indicates that a person represented by the human form may be in distress.

Embodiment 61. The method of any of embodiments 48 through 60, further comprising:

forming a third image based on information captured by the infrared sensor at an earlier time than a time that the first information was captured by the infrared sensor; and including both the third image and the first image in the analyzing.

Embodiment 62. The method of embodiment 61, the analyzing of the first image and the third image comprising: discovering a human form shown in both the first image and the third image; determining an amount of movement of the human form between the third image and the first image; and ascertaining that the amount of movement indicates that a person represented by the human form may be in distress.

Embodiment 63. At least one non-transitory machine readable medium comprising one or more instructions that in response to being executed on a computing device cause the computing device to carry out a method according to any one of embodiments 48 to 62.

Unless otherwise indicated, all numbers expressing quantities, properties, measurements, and so forth, used in the specification and claims are to be understood as being modified in all instances by the term “about.” The recitation of numerical ranges by endpoints includes all numbers subsumed within that range, including the endpoints (e.g. 1 to 5 includes 1, π, and 5).

As used in this specification and the appended claims, the singular forms “a”, “an”, and “the” include plural referents unless the content clearly dictates otherwise. Furthermore, as used in this specification and the appended claims, the term “or” is generally employed in its sense including “and/or” unless the content clearly dictates otherwise. As used herein, the term “coupled” includes direct and indirect connections. Moreover, where first and second devices are coupled, intervening devices including active devices may be located there between.

The description of the various embodiments provided above is illustrative in nature and is not intended to limit this disclosure, its application, or uses. Thus, different variations beyond those described herein are intended to be within the scope of embodiments. Such variations are not to be regarded as a departure from the intended scope of this disclosure. As such, the breadth and scope of the present disclosure should not be limited by the above-described embodiments, but should be defined only in accordance with the following claims and equivalents thereof

What is claimed is:

1. A room monitoring apparatus comprising:
an outer shell that includes a first area transparent to at least some wavelengths of infrared radiation and opaque to visible light, a second area transparent to visible light, and a third area adapted to be positioned on a surface of the room;
a static portion fixed to a portion of the outer shell;
a rotatable portion, rotationally coupled to the static portion and including an infrared sensor positioned to receive infrared light from the room through the first area of the outer shell and an imaging sensor, separate from the infrared sensor, positioned to receive visible light from the room through the second area of the outer shell;
a motor arranged to rotate the rotatable portion with respect to the static portion;
a processor coupled to the infrared sensor and the imaging sensor; and
a communications interface coupled to the processor.

2. The apparatus of claim 1, the imaging sensor positioned at a distance away from an axis of rotation of the rotatable portion to create a parallax effect for an object in the room captured in two different images by the imaging sensor at different azimuth angles of rotation of the rotatable portion.

3. The apparatus of claim 1, further comprising a movable cover, under control of the processor, for the second area of the outer shell having a first position that blocks the visible light from the room from reaching the imaging sensor and a second position that allows the visible light from the room to reach the imaging sensor;
the rotatable portion comprising a surface that is not visible from outside of the apparatus while the movable cover is in the first position, but is visible from outside of the apparatus while the movable cover is in the second position;
the surface of the rotatable portion having a contrasting color from a region of the outer shell surrounding the second area.

4. The apparatus of claim 1, the first area of the outer shell having an annular shape and the second area located within a center area defined by the annular shape of the first area.

5. The apparatus of claim 1, the rotatable portion further comprising an energy storage device and a wireless charging receiver coupled to the energy storage device; and
the static portion comprising a wireless charging transmitter arranged to transmit power to the wireless charging receiver in the rotatable portion.

6. The apparatus of claim 1, further comprising an annular bearing coupling the static portion to the rotatable portion, the first optical data transceiver and the second optical data transceiver positioned to communicate through a center of the annular bearing;
the static portion comprising a first optical data transceiver and the communications interface; and
the rotatable portion further comprising a second optical data transceiver arranged to communicate with the first optical transceiver.

7. The apparatus of claim 1, further comprising a passive infrared detector coupled to the processor, the passive infrared detector configured to detect motion within an area visible to the infrared sensor, wherein the passive infrared detector is separate from the infrared sensor.

8. The apparatus of claim 7, wherein the second area is also transparent to the at least some wavelengths of infrared light and the passive infrared detector is positioned to receive infrared light through the second area;
the apparatus further comprising a movable cover for the second area of the outer shell that is transparent to the at least some wavelengths of infrared light and opaque to visible light.

9. The apparatus of claim 1, the infrared sensor having only a single column of infrared sensing elements arranged to receive the infrared light from a single azimuth direction at each infrared sensing element of the column of infrared sensing elements and arranged to receive the infrared light from different elevation angles at different infrared sensing elements of the column of infrared sensing elements, the single azimuth direction determined by a relative rotation between the rotatable portion and the static portion.

10. The apparatus of claim 9, wherein the column of infrared sensing elements consists of no more than 128 infrared sensing elements, so that an individual shown in a two-dimensional image formed using information from the infrared sensing elements cannot be identified.

11. The apparatus of claim 9, further comprising an optical subsystem, the optical subsystem arranged to direct the infrared light from a first elevational angle arc and a first azimuth angle arc to a first infrared sensing element of the column of infrared sensing elements and to direct the infrared light from a second elevational angle arc, smaller than the first elevational angle arc, and a second azimuth angle arc, smaller than the first azimuth angle arc, to a second infrared sensing element of the column of infrared sensing elements.

12. The apparatus of claim 9, the processor configured to:
receive first information from the infrared sensor with the rotatable portion in a first position;
move the rotatable portion to a second position;
receive second information from the infrared sensor with the rotatable portion in the second position; and
form a two-dimensional image from at least the first information and the second information;
analyze the two-dimensional image to determine whether to send the two-dimensional image to a remote computer; and
send the two dimensional image to the remote computer through the communications interface based on the determination.

13. The apparatus of claim 1, further comprising a microwave transducer, coupled to the processor which is configured to detect motion of an object in the room, the microwave transducer being directional and mounted in the rotatable portion.

14. A method for use in a room monitoring device including a static portion and a rotatable portion, the rotatable portion including an imaging sensor and an infrared sensor that has a single column of infrared sensing elements arranged to receive light from a single azimuth direction determined by a relative rotation between the rotatable portion and the static portion, the method comprising:
receiving first information from the infrared sensor with the rotatable portion in a first position;
forming a two-dimensional first image utilizing the first information;
analyzing the first image within the room monitoring device;
determining whether to forward the first image to a remote computer based on the analyzing of the first image;
sending the first image to the remote computer based on the determination;
receiving a command from remote computer;
moving the rotatable portion to a designated position based on the command;
receiving a second image from the imaging sensor, the second image having a higher spatial resolution than the first image; and
sending the second image to the remote computer.

15. The method of claim 14, further comprising:
moving the rotatable portion of the room monitoring device to a second position;
receiving second information from the infrared sensor with the rotatable portion in the second position; and
forming the first image utilizing both the first information and the second information.

16. The method of claim 15, wherein the first information and the second information both individually include infrared intensity information from only the column of infrared sensing elements, wherein the infrared sensor has no additional columns of infrared sensing elements.

17. The method of claim 14, further comprising:
receiving a wake event from a motion detector of the room monitoring device while in a low-power state;
exiting the low-power state in response to the receiving of the wake event before proceeding with the receiving of the first information.

18. The method of claim 14, the analyzing of the first image comprising:
discovering a region of the first image that shows a human form;
calculating positions of one or more extremities of the human form; and
ascertaining that the positions of the one or more extremities indicate that a person represented by the human form may be in distress.

19. The method of claim 14, the analyzing of the first image comprising:
discovering a region of the first image that shows a human form;
determining a skin temperature of the human form based on the first image; and
ascertaining that the skin temperature indicates that a person represented by the human form may be in distress.

20. The method of claim 14, further comprising:
forming a third image based on information captured by the infrared sensor at an earlier time than a time that the first information was captured by the infrared sensor; and
including both the third image and the first image in the analyzing;
the analyzing of the first image and the third image comprising:
discovering a human form shown in both the first image and the third image;
determining an amount of movement of the human form between the third image and the first image; and
ascertaining that the amount of movement indicates that a person represented by the human form may be in distress.
